(19) United States
(12) Patent Application Publication
(10) Pub. No.: US 2026/0052565 A1
(43) Pub. Date: Feb. 19, 2026

(54) BANDWIDTH ENHANCEMENTS FOR SIDELINK IN THE UNLICENSED SPECTRUM

(71) Applicant: Apple Inc., Cupertino, CA (US)

(72) Inventors: Huaning Niu, San Jose, CA (US); Seyed Ali Akbar Fakoorian, San Diego, CA (US); Oghenekome Oteri, San Diego, CA (US); Weidong Yang, San Diego, CA (US); Dawei Zhang, Saratoga, CA (US); Wei Zeng, Saratoga, CA (US); Chunxuan Ye, San Diego, CA (US); Ankit Bhamri, Bad Nauheim (DE); Hong He, San Jose, CA (US)

(21) Appl. No.: 19/101,281

(22) PCT Filed: Jul. 20, 2023
(86) PCT No.: PCT/US2023/028193

§ 371 Date: Feb. 5, 2025

Related U.S. Application Data
(60) Provisional application No. 63/396,921, filed on Aug. 10, 2022.

(51) Int. Cl. H04W 74/0808; H04W 16/14

(52) U.S. Cl. CPC H04W 74/0808; H04W 16/14

(57) ABSTRACT

Techniques discussed herein can facilitate sidelink (SL) transmissions in the unlicensed spectrum. One example aspect is a baseband processor of a user equipment (UE) including one or more processors configured to perform a first listen before talk (LBT) procedure and a second LBT procedure, where the first LBT procedure is performed according to a first LBT bandwidth (BW) (LBT BW1), and the second LBT procedure is performed according to a second LBT bandwidth (LBT BW2). The one or more processors are further configured to transmit a SL message, in an unlicensed spectrum, after completing the first LBT procedure and the second LBT procedure, where the SL message is transmitted in a SL BWP that overlaps with the LBT BW1 and the LBT BW2.

### REFERENCE TO RELATED APPLICATIONS

This Application claims the benefit of U.S. Provisional Application No. 63/396,921 filed on Aug. 10,2022, the contents of which are hereby incorporated by reference in their entirety

### FIELD

The present disclosure relates to wireless communication networks and mobile device capabilities.

### BACKGROUND

Mobile communication in the next generation wireless communication system, 5G, new radio (NR), sixth generation technology, and so on will provide ubiquitous connectivity and access to information, as well as the ability to share data, around the globe. Next generation wireless communication systems provide service-based framework that will target to meet versatile, and sometimes conflicting, performance criteria. Such technology may include solutions for enabling user equipment (UE) to communicate with one another directly.

### BRIEF DESCRIPTION OF THE DRAWINGS

FIG. 1 is an exemplary block diagram illustrating an example of user equipment(s) (UEs) communicatively coupled to a network in accordance with various aspects described herein.

FIG. 2 illustrates a diagram of slidelink (SL) unlicensed band transmissions in accordance with a SL bandwidth part (BWP) that overlaps with multiple listen-before-talk (LBT) bandwidths (BWs).

FIGS. 3A and 3B illustrate resource diagrams showing the relationship between multiple LBT BWs where a SL message associated with the SL BWP is transmitted in one or more of the multiple LBT BWs.

FIG. 4 shows a time diagram of LBT procedures for multiple LBT BWs with an independent count down before transmitting the SL message in all of the multiple LBT BWs that overlap with the SL BWP.

FIG. 5 shows a time diagram of LBT procedures for multiple LBT BWs with an independent count down before transmitting the SL message in one of the multiple LBT BWs that overlap with the SL BWP.

FIGS. 6A, 6B, 6C, 6D, and 7 illustrate resource diagrams showing multiple LBT BW and SL BWP configurations for guard band enabled, guard band disabled, interlaced waveforms, and continuous waveforms.

FIG. 8 illustrates a flow diagram of an example method by which a UE performs bandwidth enhanced SL messaging in the unlicensed spectrum.

FIG. 9 illustrates an example of an infrastructure equipment, in accordance with various aspects disclosed.

FIG. 10 illustrates an example of a UE or base station (BS) platform, in accordance with various aspects disclosed.

### DETAILED DESCRIPTION

The present disclosure is described with reference to the attached figures. The figures are not drawn to scale and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events.

Furthermore, not all illustrated acts or events are required to implement a methodology in accordance with the selected present disclosure.

The present disclosure relates to sidelink (SL) bandwidth parts (BWPs) that span multiple listen-before-talk (LBT) bandwidths (BWs), where SL transmissions associated with the SL BWPs can be adapted across the multiple LBT BWs to leverage bandwidth enhancements in the unlicensed band.

Wireless networks may include user equipments (UEs) capable of communicating with base stations (BS), wireless routers, satellites, other network nodes, and other UEs. UEs may utilize one or more types of communication technologies to communicate directly with one another. Examples of such technologies may include proximity-based service (ProSe) or device-to-device (D2D) communications, vehicle-to-anything (V2X) communications, SL communications, and the like. SL communications, as described herein, may include a scenario in which a UE operates to discover, establish a connection, and communicate, with one or more other UEs directly. As such, UEs can communicated directly with one another without going through an intermediary such as a core network (CN) or BS. Wireless networks can make use of an unlicensed spectrum for certain types of wireless activities where the unlicensed spectrum may correspond to one or more frequency bands that are not restricted for said wireless activities. In some aspects, SL communications using the unlicensed spectrum may be referred to as SL-U communications. Before a UE conducts a SL-U transmission, the UE may conduct LBT procedures as part of a clear channel assessment (CCA) process to ensure the unlicensed spectrum is clear before sending the SL transmission.

SL-U communications may involve one or more wireless resources (e.g., channels, signals, carriers, bandwidths, etc.). Since unlicensed wireless resources may be shared among various devices, operators, and radio access technologies, in some instances, communications on the unlicensed wireless resources may require the use of certain techniques, such as channel occupancy time (COT), LBT operations, and the like, to avoid conflicting use of the resources. Currently available SL-U techniques, however, fail to provide an adequate solution for wideband or bandwidth enhanced SL-U communications. For example, a SL bandwidth part (BWP) for SL transmissions may overlap multiple LBT bandwidths (BWs). LBT procedures can sense a channel, or set of frequencies that comprise a BW, to determine if the channel or BW are clear before unlicensed transmission. The frequencies over which the LBT procedure performs sensing are called the LBT BW. For example, the LBT BW can be 20 MHz, and when a LBT procedure is initiated, the UE can sense the 20 MHz LBT BW according to a time period and sensing threshold to determine if the 20 MHz LBT BW is clear or busy. However, the SL BWP defining the transmission band for SL-U can be 40 MHz, and span two 20 MHz LBT BWs. Present SL-U standards fail to provide solutions for SL transmissions spanning multiple LBT BWs, nor provide solutions for SL transmissions in intra-frequency guard bands of the LBT BWs. As such, enhancements to SL-U communications that span multiple LBT BWs can enable wideband operations or bandwidth enhancements for SL in the unlicensed band.

Various aspects of the present disclosure are directed towards SL-U transmissions according to a SL BWP that overlaps with multiple LBT BWs. Mechanisms by which the UE can perform LBT procedures associated with the multiple LBT BWs to enable SL-U transmission in the multiple LBT BWs are presented herein. Mechanisms by which the UE can perform LBT procedures associated with the multiple LBT BWs to enable SL-U transmissions in a subset of the multiple LBT BWs for faster communications are presented herein. Mechanisms by which the UE can adapt the SL BWP based on CCA procedures associated with the multiple LBT BWs are presented herein. Mechanisms by which the UE can configure the guard bands (GBs) of the multiple LBT BWs for wideband SL-U transmissions are presented herein.

As such, aspects presented herein provide bandwidth enhancements for higher throughput or faster communications for SL BWPs that overlap with multiple LBT BWs in the unlicensed band.

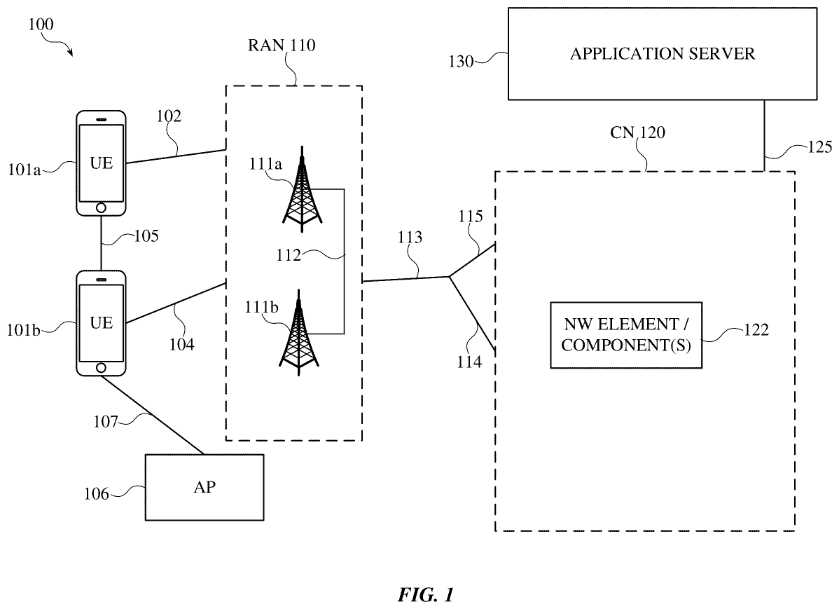

FIG. 1 illustrates an example architecture of a wireless communication system 100 of a network that includes UE 101a and UE 101b (collectively referred to as “UEs 101” or generally referred to as “UE 101”), a radio access network (RAN) 110, and a core network (CN) 120. In other aspects, the UE 101b is referred to as another UE 101b. The UEs communicate with the CN 120 by way of the RAN 110. In aspects, the RAN 110 can be a next generation (NG) RAN or a 5G RAN, an evolved-UMTS Terrestrial RAN (E-UTRAN), or a legacy RAN, such as a UTRAN or GERAN. As used herein, the term “NG RAN” or the like can refer to a RAN 110 that operates in an NR or 5G system, and the term “E-UTRAN” or the like can refer to a RAN 110 that operates in an LTE or 4G system. The UEs 101 utilize connections 102 and 104, in some aspects, connections 102 and 104 are referred to as channels, each of which comprises a physical communication interface/layer. Connections 102 and 104 (also referred to as channels) can facilitate one or more of licensed or unlicensed communication bands between the UE 101 and the RAN 110.

Alternatively, or additionally, each of the UEs 101 can be configured with dual connectivity (DC) as a multi-RAT or multi-Radio Dual Connectivity (MR-DC), where a multiple Rx/Tx capable UE may be configured to utilize resources provided by two different nodes (e.g., 111a, 111b, 112, or other network nodes) that can be CONNECTED via non-ideal backhaul, one providing NR access and the other one providing either E-UTRA for LTE or NR access for 5G, for example.

Alternatively, or additionally, each of the UEs 101 can be configured in a CA mode where multiple frequency bands are aggregated amongst component carriers (CCs) to increase the data throughput between the UEs 101 and base stations (BSs) (also referred to herein as “node” or “nodes”), for example, BS 111a and another BS 111b. For example, UE 101a can communicate with BS 111a according to the CCs in CA mode. Furthermore, UE 101a can communicate with BSs 111 in a DC mode simultaneously and additionally communicate with each node of BSs 111 in the CA mode.

In this example, the connections 102 and 104 are illustrated as an air interface to enable communicative coupling. In aspects, the UEs 101 can directly exchange communication data via a ProSe interface. The ProSe interface can alternatively be referred to as a sidelink (SL) interface 105 and can comprise one or more logical channels. In other aspects, the ProSe interface can be a direct (peer-to-peer) communication.

The RAN 110 can include one or more access nodes (AN) or RAN nodes (collectively referred to as “RAN nodes” or generally referred to as “RAN node”) that enable the connections 102 and 104. As used herein, the terms “access node,” “access point,” or the like can describe equipment that provides the radio baseband functions for data and/or voice connectivity between a network and one or more users. These access nodes can be referred to as a base station (BS), next generation base station (gNBs), RAN nodes, evolved next generation base station (eNBs), NodeBs, RSUs, Transmission Reception Points (TRxPs) or TRPs, and so forth. As such, the BS can be referred to herein as BS 111a, BS 111b, collectively as BSs 111 or generally as BS.

In aspects where the wireless communication system 100 is a 5G or NR system, the interface 112 can be an Xn interface. The Xn interface is defined between two or more BSs 111 (e.g., two or more BS or the like) that connect to 5GC, between a BS 111a (e.g., a RAN node or gNB) connecting to 5GC and an eNB, and/or between two eNBs connecting to 5GC.

The UE 101 and the BSs 111 may utilize a Uu interface to exchange control plane data via a protocol stack comprising the PHY layer (e.g., layer 1 (L1)), the MAC layer (e.g., layer 2 (L2)), the RLC layer, the PDCP layer, and the radio resource control (RRC) layer (e.g., layer 3 (L3)). The Uu interface can be one or more of connections 102 and 104.

UEs 101 may communicate and establish a connection with one or more other UEs via the SL interface 105, or more than one SL interface 105, each of which may comprise a physical communications interface/layer. UEs 101 may be configured to discover one another, negotiate wireless resources between one another, and establish connections between one another, without intervention or communications with BSs 111 or another type of network node. In some implementations, discovery, authentication, resource negotiation, registration, etc., may involve communications with BSs 111 or another type of network node.

UEs (e.g., UE 101a or another UE 101b) may use the SL interface 105 to communicate with one another. As described herein, UE 101a may communicate with BS 111a to request SL resources over connection 102. BS 111a may respond to the request by providing UE 101a with a dynamic grant (DG) or configured grant (CG) regarding SL resources. UE 101a may perform a clear channel assessment (CCA) procedure based on the DG or CG, select SL resources based on the CCA procedure and the DG or CG; and communicate with another UE 101b, based on the SL resources. The UE 101a may communicate with the BS 111a using a licensed frequency band and communicate with another UE 101b using an unlicensed frequency band.

Further, BSs 111 may be configured to wirelessly communicate with UEs 101, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, or other ranges. In some regions, the unlicensed spectrum may include the 5 GHz band, or other ranges. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 101 and the BSs 111 may operate using stand-alone unlicensed operation, licensed assisted access (LAA), eLAA, and/or feLAA mechanisms. In these implementations, UEs (e.g., UE 101a or another UE 101b) and the BSs 111 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

In aspects, the CN 120 can be a 5GC (referred to as “5GC 120” or the like), and the RAN 110 can be CONNECTED with the CN 120 via interface 113, which can be referred to as a next generation (NG) interface. In aspects, the NG interface can be split into two parts, a NG user plane (NG-U) interface 114, which carries traffic data between the BSs 111 and a User Plane Function (UPF), and the S1 control plane (NG-C) interface 115, which is a signaling interface between the BSs 111 and Access and Mobility Management Functions (AMFs).

In aspects, where CN 120 is an evolved packet core (EPC) (referred to as “EPC 120” or the like), the RAN 110 can be CONNECTED with the CN 120 via an S1 interface (indicated by NG-U interface 114). In aspects, the S1 interface 113 can be split into two parts, an S1 user plane (S1-U) interface, which carries traffic data between the BSs 111 and the S-GW, and the S1-MME interface, which is a signaling interface between the BSs 111 and MMEs.

The RAN 110 is shown to be communicatively coupled to a core network—in this aspect, CN 120. The CN 120 can comprise a plurality of network components 122 (or network devices), which are configured to offer various data and telecommunication services to customers/subscribers (e.g., users of UEs 101) that are CONNECTED to the CN 120 via the RAN 110.

The UE 101a can determine to transmit a SL message with a SL BWP that overlaps with a first LBT BW (LBT BW1) and a second LBT BW (LBT BW2), where LBT BW1 and LBT BW2 are adjacent. The UE 101a can perform a first LBT procedure associated with LBT BW1 and a second LBT procedure associated with LBT BW2 according to SL interface 105 to determine if the LBT BW1 and LBT BW2 are clear for SL-U transmissions. After performing the first and second LBT procedure, the UE 101a can transmit the SL message in the unlicensed spectrum according to SL interface 105, to another UE 101b. The SL message can be transmitted in a SL BWP that overlaps with one or more of LBT BW1 or LBT BW2. In some aspects, the UE 101a receives a guard band configuration from the BS 111a over connection 102 by radio resource control (RRC) signaling. As such, the UE 101 can configure the SL message in a guard band of the LBT BW1 and LBT BW2.

### SL-U Communications With Bandwidth Enhancements

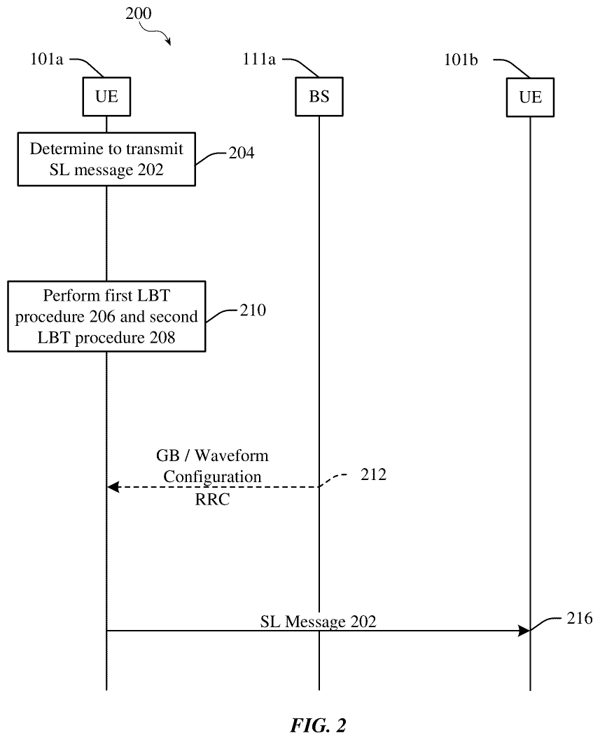

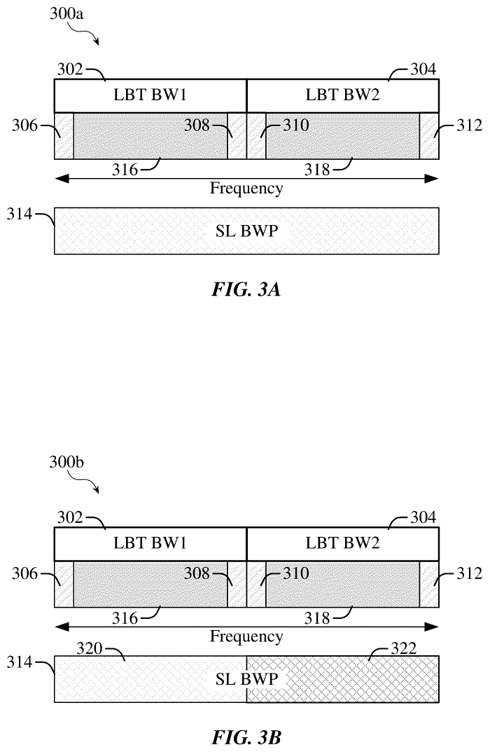

FIG. 2 illustrates a diagram 200 of SL-U transmissions in accordance with a SL BWP that overlaps with multiple LBT BWs. In diagram 200, the UE 101a can be the UE 101a FIG. 1, the BS 111a can be the BS 111a of FIG. 1 and the another UE 101b can be the another UE 101b of FIG. 1. FIGS. 3A and 3B illustrate resource diagrams 300a and 300b respectively showing the relationship between a first LBT BW (LBT BW1) 302, a second LBT BW (LBT BW2) 304, and a SL BWP 314. Diagram 200 is described briefly below and referred to herein in more detail in subsequent figures. Now referring to FIGS. 2, 3A, and 3B concurrently.

At 204, the UE 101a determines to transmit a SL message 202 in the unlicensed band. FIGS. 3A and 3B depict an example arrangement of the SL BWP 314 overlapping two, that is, overlapping LBT BW1 302 and LBT BW2 304. The SL message 202 can be transmitted over a SL BWP 314. The SL BWP 314 can overlap, in frequency, with the LBT BW1 302 and the LBT BW2 304. LBT BW1 302 and LBT BW2 304 are adjacent to one another, and are continuous in frequency. LBT BW1 302 and LBT BW2 304 can be referred to generally as multiple LBT BWs, where multiple LBT BWs refers generally to a plurality of LBT BWs that are adjacent to one another. LBT BW1 includes a first LBT BW1 guard band 306 and a second LBT BW1 guard band 308. The first LBT BW1 guard band 306 can be referred to as GB1A 306 and the second LBT BW1 guard band 308 can be referred to as GB1B 308. LBT BW2 comprises a first LBT BW2 guard band 310 and a second LBT BW2 guard band 312. The first LBT BW2 guard band 310 can be referred to as GB2A 310 and the second LBT BW2 guard band 312 can be referred to as GB2B 312.

A guard band is an unused part of the radio spectrum between radio bands to prevent interference between radio bands. As such, transmissions generally do not extend into the GB. GB1A 306 prevents interference between LBT BW1 302 and a radio band lower in frequency relative to LBT BW1 302. GB1B 308 prevents interference between LBT BW1 302 and LBT BW2 304. GB2A 310 prevents interference between LBT BW2 304 and LBT BW1 302. As such, GB1B 308 and GB2A 310 are intra-frequency guard bands from the perspective of the SL BWP 314. GB2B 312 prevents interference between LBT BW2 304 and a radio band higher in frequency relative to LBT BW2 304. As such, GB1A 306 is separated from GB1B 308 by a first usable BW 316 of LBT BW1 302, and GB2A 310 is separated from GB2B 312 by a second usable BW 318 of LBT BW2 304. A usable BW is a BW of a channel that can be used for uplink (UL) or downlink (DL) signaling or sensing without causing interference for out of channel bands. As seen in FIGS. 3A and 3B, the SL BWP 314 covers LBT BW1 302 and LBT BW2 304.

After determining to transmit the SL message 202 at 204, the UE 101 performs a first LBT procedure 206 associated with LBT BW1 302, and a second LBT procedure 208 associated with LBT BW2 304. As the SL message 202 is transmitted in the unlicensed band, the UE 101 performs the first LBT procedure 206 and the second LBT procedure 208 according to a CCA configuration to determine that the transmission channel (e.g., LBT BW1 302 and LBT BW2 304) are clear, or not busy, before transmitting the SL message 202.

At 216, the UE 101a transmits, by SL interface 105, the SL message 202 to another UE 101b in the unlicensed spectrum. The SL message 202 can be transmitted in multiple LBT BWs, for example, the SL message can be transmitted in the SL BWP 314 that overlaps with LBT BW1 302 and LBT BW2 304 after the first LBT procedure 206 and the second LBT procedure 208 are successfully completed. In this aspect, the transmission BW of the SL message 202 is enhanced by using multiple LBT BWs by broadening the SL message 202 transmission BW compared to a SL message transmitted in a single LBT BW. FIG. 3A shows an example of SL message 202 transmission in multiple LBT BWs and is discussed further herein. Alternatively, the SL message 202 can be transmitted in a subset of the multiple LBT BWs, for example, the SL message can be transmitted in the SL BWP 314 that overlaps with one of LBT BW1 302 or LBT BW2 304. In this aspect, the transmission BW of the SL message 202 is restricted to a first completed LBT procedure, for example, the first LBT procedure 206 or the second LBT procedure 208, whichever successfully completes first. In this aspect, the UE 101a leverages the multiple LBT BWs, and prioritizes transmitting the SL message 202 earlier in time according to the first completed LBT procedure. FIG. 3B shows an example of SL message 202 transmission in a subset of the multiple LBT BWs and is discussed further herein. While diagram 200 shows the transmission at 216 to another UE 101b, it is understood that the UE 101a could transmit SL message 202 to a group of UEs.

In some aspects, the BS 111a may optionally transmit, by connection 102, to UE 101a, a guard band or waveform configuration through RRC signaling at 212 before the UE 101a transmits the SL message 202. The guard band configuration can indicate how the UE 101a can use the guard bands of LBT BW1 302 and LBT BW2 304 for SL message 202. As such, in some examples, the UE 101a may transmit the SL message 202 in one or more guard bands based on the guard band configuration. Additionally or alternatively, the UE 101a can configure a waveform of the SL message 202 based on the waveform configuration. The waveform can be a continuous or interlaced waveform and the UE 101a can determine which portions of the usable BW of the multiple LBT BWs to transmit the SL message 202 based on the waveform configuration. Aspects of the guard band and waveform configuration are discussed further herein.

### SL-U Communications in Multiple LBT BWs

FIG. 3A illustrates resource diagram 300a showing the relationship between LBT BW1 302, LBT BW2 304, and a SL BWP 314, where the SL message 202 associated with the SL BWP 314 is transmitted in both LBT BW1 302 and LBT BW2 304. Aspects described in accordance with FIG. 3A describes SL-U communications in multiple LBT BWs when the SL BWP 314 of the SL message 202 overlaps multiple LBT BWs. In this example, the UE 101a can achieve wideband transmission of the SL message 202 in the unlicensed band relative to SL message 202 transmissions in a single LBT BW. In some aspects, the UE 101a can determine to transmit the SL message 202 according to a pre-configuration or hard coded instruction set. In other aspects, the UE 101a can determine to transmit the SL message 202 in multiple LBT BWs according to a UE 101a capability, where the UE 101a reports support for multiple LBT BW transmissions to the BS 111a, and the BS 111a enables multiple LBT BW transmissions.

While resource diagram 300a shows two LBT BWs (e.g., LBT BW1 302 and LBT BW2 304), this example is non-limiting and aspects discussed herein could apply to any number of LBT BWs. In accordance with operations described at 210 of FIG. 2, the UE 101a performs CCA procedures according to the first LBT procedure 206 and the second LBT procedure 208 in LBT BW1 302 and LBT BW2 respectively. After the first LBT procedure 206 and the second LBT procedure 208 complete successfully, the SL message 202 is transmitted at 216 across LBT BW1 302 and LBT BW2 304 that overlap with the SL BWP 314. In other words, when the SL BWP 314 associated with the SL message 202 overlaps multiple LBT BWs, the SL message 202 is transmitted in the multiple LBT BWs after CCA procedures of the multiple LBT BWs are successfully completed.

CCA procedures can include LBT categories or types that describe channel sensing operations to determine if the channel is clear or busy. LBT categories include a category 2 (CAT-2), also referred to as a one-shot LBT procedure, or a type 2 LBT, and a category 4 (CAT-4) LBT, also referred to as a type 1 LBT.

The CAT-2 LBT is a LBT procedure without a back-off or a random back-off. The CAT-2 LBT can include channel (e.g., LBT BW1 302 and LBT BW2 304) sensing for a duration, and if the channel is idle or clear during the duration, the channel can be accessed. If the channel is not idle or clear during the duration, then the channel can be sensed again according to a sensing interval for the period of time.

The CAT-4 LBT is a LBT procedure with a random back-off according to a contention window (CW) of a variable size. As such, the CW has a fixed length or size (CWS) that can vary according to at least one sensed channel conditions or other factors. Implementation of CAT-4 LBT involves the UE 101a implementing a back-off from the channel (where the UE 101a does not transmit in the channel, e.g., LBT BW1 302 and LBT BW2 304) for a period of time according to a random number drawn from a set of numbers. The contention window can be variable in size based on channel characteristics. As such, the UE 101a senses the channel during the back-off to determine if the channel is clear or busy. If the channel is busy, the UE 101a pauses a CAT-4 LBT counter and continues sensing the channel. If the associated sensing slot is clear, the UE 101a resumes count down of the CAT-4 LBT counter in the contention window. The random back-off is adopted to avoid collisions when interference occurs during a previous transmission in the unlicensed spectrum. In some examples, a back-off mechanism can include increasing the CWS to a next value when interference is detected and reducing or resetting the CWS when interference is not detected. In some examples, the back-off mechanism is an exponential back-off after the UE 101a determines the channel is not clear.

When the CAT-4 LBT counter is decremented to 0, the CAT-4 LBT procedure completes successfully.

After the UE 101a determines that the channel is clear (e.g., by sensing less than a threshold amount of energy in the channel during the CW or detecting a particular sequence), the UE 101a can acquire a SL channel occupancy time (COT). The SL COT can indicate a time which the UE 101a can transmit its data payload (e.g., SL message 202) and receive feedback signals from other devices.

The CAT-2 LBT has the benefit of achieving a faster time to unlicensed band transmissions relative to the CAT-4 LBT due to not using the backoff timer. The CAT-4 LBT starts a SL-COT transmission. The LBT procedures associated with the multiple LBT BWs can be performed according to the CAT-2 LBT or the CAT-4 LBT. For example, the first LBT procedure 206 and the second LBT procedure 208 can be performed according to the CAT-2 LBT or the CAT-4 LBT.

The UE 101a can perform the first LBT procedure and the second LBT procedure according to various aspects described herein. For example, the UE 101a can perform CCA of the multiple LBT BWs according to a random selection at 210. In this option, the UE 101a randomly selects one of LBT BW1 302 or LBT BW2 304. The UE 101a can perform a primary LBT procedure where the primary LBT procedure is the first LBT procedure 206 or the second LBT procedure associated with the randomly selected one of LBT BW1 302 or LBT BW2 304. After performing the primary LBT procedure, the UE 101a performs a secondary LBT procedure, where the secondary LBT procedure is one of the first LBT procedure 206 or the second LBT procedure 208 that is not the primary LBT procedure. After the primary LBT procedure, and the secondary LBT procedure are performed successfully, the SL message 202 is transmitted at 216 in LBT BW1 302 and LBT BW2 304 that overlap with the SL BWP 314. If either the first LBT procedure 206 or the second LBT procedure 208 fail, the SL message 202 does not transmit in either the LBT BW1 302 or the LBT BW2 304. In some examples, the primary LBT procedure is performed according to the CAT-4 LBT and the secondary LBT procedure is performed according to the CAT-2 LBT. In this aspect, after the UE 101a determines the primary LBT procedure (e.g., one of the first LBT procedure 206 or the second LBT procedure 208) is successful according to the CAT-4 LBT, the UE 101a can determine that the LBT BW1 302 and the LBT BW2 304 are likely clear. As such, the UE 101a performs the secondary LBT procedure according to one of the first LBT procedure 206 or the second LBT procedure 208 that is not the primary LBT procedure according to the CAT-2 LBT in order to transmit sooner across LBT BW1 302 and LBT BW2 304 relative to performing a CAT-4 LBT for the first LBT procedure 206 and the second LBT procedure 208.

The example depicted in FIG. 3A shows two LBT BWs, which is non-limiting. The SL BWP 314 may overlap with more than two LBT BWs. When the SL BWP 314 overlaps with more than two LBT BWs, the primary LBT procedure is the CAT-4 LBT and all subsequent LBT procedures (e.g., the secondary LBT procedure, a tertiary LBT procedure, and the like) associated with the remaining more than two LBT BWs are performed according to the CAT-2 LBT.

In another option, the UE 101a can perform CCA of the multiple LBT BWs according to a selection criteria at 210. This option is similar to performing CCA of the multiple LBT BWs according to the random selection discussed above, where the multiple LBT BWs are selected based on a selection criteria rather than according to a random selection. As such, the UE 101a selects one of LBT BW1 302 or LBT BW2 304 according to a selection criteria at 210. The UE 101a performs the primary LBT procedure, where the primary LBT procedure is the first LBT procedure 206 or the second LBT procedure associated with the selected one of LBT BW1 302 or LBT BW2 304 based on the selection criteria. After performing the primary LBT procedure, the UE 101a performs the secondary LBT procedure, where the secondary LBT procedure is one of the first LBT procedure 206 or the second LBT procedure 208 that is not the primary LBT procedure. The primary LBT procedure can be the CAT-4 LBT and the secondary LBT procedure can be the CAT-2 LBT. By selecting the primary LBT procedure based on the selection criteria, the UE 101a can prioritize multiple LBT BWs based on channel sensing criteria, a pre-configuration, UE capability, known channel conditions, or the like. Furthermore, selecting the primary LBT procedure based on the selection criteria can result in uniform selection of one of the multiple LBT BWs. For example, the UE 101a may be pre-configured with selection criteria based on an index of the multiple LBT BWs. As such, the selection criteria can be based on an index value of LBT BW1 302 or an index value of the second LBT BW2 304. In some examples, the selection criteria can indicate selecting the lowest indexed LBT BW within the SL BWP 314 which can be LBT BW1 302. In other examples, the selection criteria can indicate selecting a middle or highest indexed LBT BW of the multiple LBT BWs.

In another option, the UE 101a can perform CCA of the multiple LBT BWs including ending the primary LBT procedure early at 210. This option can apply to the random selection option and selection criteria option presented above with an alternative operation to end the primary LBT procedure early before completing the CAT-4 LBT (or abort the primary LBT procedure), and subsequently performing the secondary LBT procedure according to the CAT-2 LBT. For example, the primary LBT procedure can be the CAT-4 LBT. The CAT-4 LBT includes a back-off counter, where when the UE 101a determines a LBT BW (e.g., LBT BW1 302 or LBT BW2 304) associated with the primary LBT procedure is busy, the primary LBT procedure includes sensing the LBT BW for a period of time. After sensing the LBT BW for the period of time, the UE 101a decrements the back-off counter, and can repeat sensing the LBT BW. When the back-off counter is equal to one or equal to zero, the UE 101a can end the primary LBT procedure early, or abort the primary LBT procedure, and subsequently perform the secondary LBT procedure according to the CAT-2 LBT. The UE 101a can transmit the SL message 202 after completing the secondary LBT procedure according to.

As the primary LBT procedure for the CAT-4 LBT includes a back-off the UE 101a may be able to transmit the SL message 202 sooner by aborting the primary LBT procedure and performing the secondary LBT procedure according to CAT-2 LBT.

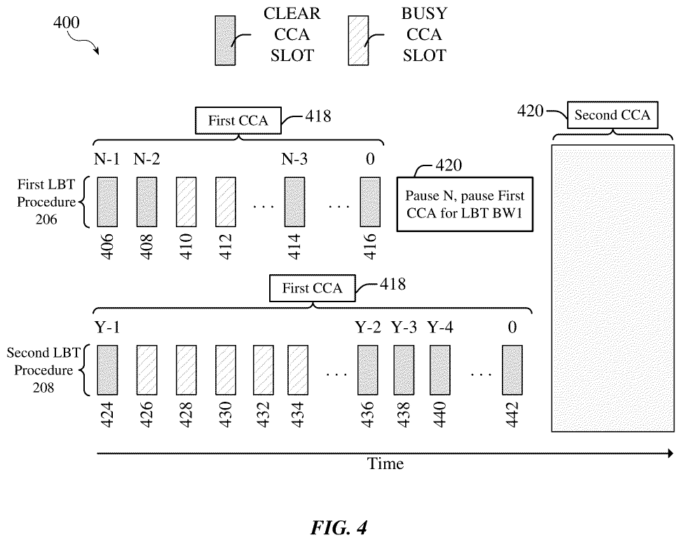

FIG. 4 shows a time diagram 400 of LBT procedures for LBT BW1 302 and LBT BW2 304 with an independent count down before transmitting the SL message 202 in LBT BW1 302 and LBT BW2 304 that overlap with the SL BWP 314. FIG. 4 shows LBT procedures for the LBT BWs that can be paused and can be switched from a first CCA 418 to a second CCA 420 to provide. In this example, the CAT-4 LBT and the CAT-2 LBT can be performed on all of the LBT BWs. The UE 101a can draw a first random number (N) for the first LBT procedure 206 and a second random number (Y) for the second LBT procedure 208. As such, the first LBT procedure 206 and the second LBT procedure 208 can be performed concurrently and independently based on a first CCA 418 (e.g., CAT-4 LBT), and when either N or Y counts down to zero, the LBT procedure associated with the zero countdown is paused (e.g., N counts down to zero and the first LBT procedure 206 is paused) while the other LBT procedure counts down to zero (e.g., Y counts down to zero and the second LBT procedure 208 completes) based on detecting N or Y subsequent clear CCA slots. After both N and Y count down to zero, the first LBT procedure 206 and the second LBT procedure 208 are updated to the second CCA 420 (e.g., CAT-2 LBT). The UE 101a performs the first LBT procedure 206 and the second LBT procedure 208 according to the second CCA 420, independently, and concurrently, and after completion of the second CCA 420, the UE 101a transmits the SL message 202. By randomly generating Y and N, the transmission time for SL message 202 is randomized to avoid interference. Y and N can be randomly generated based on a CWS of the associated LBT BW.

The time diagram 400 shows CCA slots across time, where solid CCA slots are clear CCA slots (e.g., CCA slots 406, 408, 414, 416, 424, 436, 438, 440 and 442) and hashed CCA slots are busy CCA slots (e.g., CCA slots 410, 412, 426, 428, 430, 432, and 434). The LBT procedures (e.g., first LBT procedure 206 and second LBT procedure 208) include an associated CCA procedure (e.g., CAT-2 LBT or CAT-4 LBT), and after performing the associated CCA procedure, determines the measured bandwidth (e.g., LBT BW1 302 or LBT BW2 304) associated with the CCA slot is clear or busy. A clear CCA slot is a slot where the UE 101a performs energy sensing over the LBT BW, and the energy sensing over the LBT BW is lower than an energy detection threshold. A busy CCA slot is a slot where the UE 101a performs energy sensing over the LBT BW, and the energy sensing over the LBT BW is higher than the energy detection threshold.

The first LBT procedure 206 and the second LBT procedure 208 begin at a same time where CCA slot 406 is measured according to LBT BW1 302 and the first CCA 418 (e.g., CAT-4 LBT). Concurrently, CCA slot 424 is measured according to LBT BW2 304 and the first CCA 418. When the first LBT procedure 206 detects that a measured CCA slot is clear, the UE 101a decrements N. For example, the UE 101a performs the first CCA 418 at CCA slots 406 and 408 where N is decremented by N-1 and N-2 accordingly. The UE 101a performs the first CCA 418 subsequently at CCA slots 410 and 412 and determines that LBT BW1 302 is busy, and thus N is not decremented. The UE 101a continues to perform the first CCA 418 at CCA slot 414 through CCA slot 416 where N decrements to zero at CCA slot 416. Concurrently, the UE 101a measures LBT BW2 304 and decrements Y to Y-1 after determining CCA slot 424 is clear, does not decrement CCA slots 426, 428, 430, 432, and 434 as said CCA slots are busy, and subsequently determines CCA slots 436, 438, 440 and 442 are clear where Y decrements to zero at CCA slot 442.

When the UE 101a determines that N decrements to zero before Y decrements to zero, the UE 101a pauses N, pauses the first LBT procedure 206, and continues performing the second LBT procedure 208 (e.g., the first LBT procedure 206 decrements N to zero at CCA slot 416 and the second LBT procedure 208 decrements Y to zero at CCA slot 442 later in time relative to CCA slot 416). As such, the UE 101a saves resources by pausing the first LBT procedure 206 while the second LBT procedure 208 continues. After the UE 101a determines that Y decrements to zero at CCA slot 442, the UE 101a pauses the second LBT procedure. In some aspects, the UE 101a can transmit the SL message after N and Y decrement to zero, in other aspects, the UE 101a can update the first LBT procedure 206 and the second LBT procedure 208 to the second CCA 420. In some aspects, the UE 101a updates the first LBT procedure 206 and the second LBT procedure 208 to the second CCA 420 after Y decrements to zero, and subsequently simultaneously performs the first LBT procedure 206 and the second LBT procedure 208 according to the second CCA 420 (e.g., CAT-2 LBT). The UE 101a transmits the SL message 202 after the first LBT procedure 206 and the second LBT procedure 208 complete the second CCA 420.

While FIG. 4 shows the first LBT procedure 206 decrementing to zero before the second LBT procedure 208, it is understood the example is non-limiting. In an alternative example, the second LBT procedure 208 can decrement to zero before the first LBT procedure 206. In yet another alternative example the SL BWP can overlap multiple LBT BWs where the multiple LBT BWs are more than the two LBT BWs discussed in accordance with FIG. 4. As such, the first CCA 418 would concurrently and independently be performed by LBT procedures associated with the multiple LBT BWs, and LBT procedures would be paused after randomly generated counters are decremented to zero. After all of the LBT procedures count down to zero, all of the LBT procedures would update to the second CCA and the SL message 202 is transmitted in the multiple LBT BWs after completion of the second CCA.

### SL-U Communications in Multiple LBT BWs

FIG. 3B illustrates resource diagram 300b showing the relationship between LBT BW1 302, LBT BW2 304, and a SL BWP 314, where the SL message 202 associated with the SL BWP 314 is transmitted in one of LBT BW1 302 or LBT BW2 304. Now referring concurrently to FIGS. 2 and 3B. Aspects described in accordance with FIG. 3B discuss SL-U communications where the SL BWP 314 of the SL message 202 overlaps multiple LBT BWs, and the SL message 202 is transmitted in one of the multiple LBT BWs according to a first completed LBT procedure. In this example, the UE 101a can transmit the SL message 202 sooner in time based on a first completed LBT procedures of multiple LBT procedures associated with the multiple LBT BWs. As such, the SL message 202 is transmitted sooner in the unlicensed band according to the first completed LBT procedure relative to SL message 202 transmissions in multiple LBT BWs where all of the LBT procedures complete successfully before SL-U transmissions. In some aspects, the UE 101a can determine to transmit the SL message 202 according to a pre-configuration or hard coded instruction set. In other aspects, the UE 101a can determine to transmit the SL message 202 in one LBT BW of the multiple LBT BWs that overlap with the SL BWP 314 according to a UE 101a capability, where the UE 101a reports support for multiple LBT BW transmissions to the BS 111a, and the BS 111a enables multiple LBT BW transmissions.

While resource diagram 300b shows two LBT BWs (e.g., LBT BW1 302 and LBT BW2 304), this example is non-limiting and aspects discussed herein could apply to any number of LBT BWs. In accordance with operations described at 210 of FIG. 2, the UE 101a performs CCA procedures according to the first LBT procedure 206 and the second LBT procedure 208 in LBT BW1 302 and LBT BW2 304 respectively. LBT operations are performed on LBT BW1 302 and LBT BW2 304 are concurrently, and the UE 101a determines a first completed LBT procedure. The first completed LBT procedure is one of the first LBT procedure 206 or the second LBT procedure 208 that completes first. The SL message 202 is transmitted at 216 in a SL BW of the first completed LBT procedure. In other words, when the SL BWP 314 associated with the SL message 202 overlaps multiple LBT BWs (e.g., LBT BW1 302 and LBT BW2 304), the SL message 202 is transmitted in part of the SL BWP 314 that overlaps with the LBT BW associated with the first completed LBT.

The UE 101a can perform the first LBT procedure and the second LBT procedure according to various aspects described herein. For example, the UE 101a can perform CCA of the multiple LBT BWs according to a random selection at 210. In this option, the UE 101a randomly selects one of the LBT BW1 302 or the LBT BW2 304. The UE 101a can perform a primary LBT procedure in the randomly selected one of LBT BW1 302 or LBT BW2 304. After performing the primary LBT procedure, the UE 101a determines the first completed LBT procedure. The UE 101a transmits the SL message 202 after performing the primary LBT procedure and after determining the first completed LBT procedure. After the primary LBT procedure and the first completed LBT procedure are performed successfully, the SL message 202 is transmitted at 216 in the SL BW of the first completed LBT procedure. For example, the SL BWP 314 is comprised of a first half SL BWP 320 and a second half SL BWP 322. If the first LBT procedure 206 is the first completed LBT procedure, then the SL BW of the first completed LBT procedure is the first half SL BWP 320 and the SL message 202 is transmitted in the first half SL BWP 320 which overlaps with, and is the same as, the LBT BW1 302. In some examples, the SL BWP 314 is reconfigured to the first half SL BWP 320 before the SL message 202 is transmitted.

If either the primary LBT procedure or the first completed LBT procedure fail, the SL message 202 does not transmit in either the LBT BW1 302 or the LBT BW2 304. In some examples, the primary LBT procedure is performed according to the CAT-4 LBT and the first completed LBT procedure is performed according to the CAT-2 LBT.

In this aspect, after the UE 101a determines the primary LBT procedure is successful according to the CAT-4 LBT, the UE 101a can determine that LBT BW1 302 and LBT BW2 304 may be clear for SL-U operations. The UE 101a then configures the CAT-2 LBT, which can finish faster than a CAT-4 LBT, for the first LBT procedure 206 and the second LBT procedure 208. By transmitting the SL message 202 in the first completed LBT procedure, the UE 101a prioritizes SL message 202 transmission earlier in time over wider band operation.

The example depicted in FIG. 3B shows two LBT BWs, which is non-limiting. The SL BWP 314 may overlap with more than two LBT BWs. When the SL BWP 314 overlaps with more than two LBT BWs, the primary LBT procedure is the CAT-4 LBT, after the primary LBT procedure completes, all subsequent LBT procedures (e.g., the first LBT procedure 206, the second LBT procedure 208, a third LBT procedure, and the like) associated with the remaining more than two LBT BWs are performed according to the CAT-2 LBT.

In another option, the UE 101a can perform CCA of the multiple LBT BWs according to a selection criteria at 210. This option is similar to performing CCA of the multiple LBT BWs according to the random selection discussed above, where the multiple LBT BWs are selected based on a criteria rather than according to a random selection. As such, the UE 101a selects one of LBT BW1 302 or LBT BW2 304 according to a selection criteria at 210. The UE 101a performs the primary LBT procedure, where the primary LBT procedure is performed in the selected one of LBT BW1 302 or LBT BW2 304 according to the selection criteria. After performing the primary LBT procedure, the UE 101a determines the first completed LBT procedure based on the first LBT procedure 206 or the second LBT procedure 208. The UE 101a transmits the SL message after performing the primary LBT procedure and determining the first completed LBT procedure. The primary LBT procedure can be the CAT-4 LBT and the first LBT procedure 206 and the second LBT procedure 208 are the CAT-2 LBT. By selecting the primary LBT procedure and the secondary LBT procedure based on the selection criteria, the UE 101a can prioritize multiple LBT BWs based on channel sensing criteria, a pre-configuration, UE capability, known channel conditions, or the like. Furthermore, selecting the primary LBT procedure based on the selection criteria can result in a uniform selection of one of the multiple LBT BWs. For example, the UE 101a may be pre-configured with selection criteria based on an index of the multiple LBT BWs. As such, the selection criteria can be based on an index value of LBT BW1 302 or an index value of the second LBT BW2 304. In some examples, the selection criteria can indicate selecting the lowest indexed LBT BW within the SL BWP 314 which can be LBT BW1 302. In other examples, the selection criteria can indicate selecting a middle or highest indexed LBT BW of the multiple LBT BWs.

In an alternative example with multiple LBT BWs, the first completed LBT does not include CAT-2 LBT performed on the LBT BW associated with the primary LBT procedure. In this aspect, less resources are designated to CCA as fewer CCA procedures are performed relative to examples where CAT-2 LBT is performed on the LBT BW associated with the primary LBT procedure. For example the SL BWP 314 overlaps with a plurality of LBT BWs. The UE 101a randomly selects, or selects based on the selection criteria, a primary LBT BW that is one of the plurality of LBT BWs. The primary LBT procedure is the CAT-4 LBT performed in the primary LBT BW randomly selected or selected based on the selection criteria. Subsequently, the UE 101a performs independent and concurrent CAT-2 LBT in the plurality of LBT BWs other than the primary LBT BW. As such, if the primary LBT BW is a first LBT BW of the plurality of LBT BWs, and the primary LBT procedure is a first LBT procedure, the independent and concurrent CAT-2 procedures are performed according to a second LBT BW, a third LBT BW, etc. of the plurality of LBT BWs. Furthermore, the independent and concurrent CAT-2 procedures are performed according to a second LBT procedure, a third LBT procedure, etc. associated with the second LBT BW, the third LBT BW, and the like of the plurality of LBT BWs. The first completed LBT procedure is second LBT procedure, third LBT procedure, etc. that completes first. The SL message 202 is transmitted after performing the primary LBT procedure and determining the first completed LBT procedure in a LBT BW associated with the first completed LBT procedure.

In a related example, the primary LBT procedure is performed in one of LBT BW1 302 or LBT BW2 304 that is randomly selected or selected based on the criteria, and the primary LBT procedure is the first LBT procedure 206 or the second LBT procedure 208 associated with the selected one of LBT BW1 302 or LBT BW2 304. After the primary LBT procedure is completed, a secondary LBT procedure is performed where the secondary LBT procedure is the first LBT procedure 206 or the second LBT procedure 208 that is not the primary LBT procedure. The first completed LBT procedure is the secondary LBT procedure in this example. Additionally, when the SL BWP 314 overlaps with more LBT BWs, for example, LBT BW3, LBT BW4, etc. (not pictured), the UE 101a configures a third LBT procedure, fourth LBT procedure, etc. respectively. The primary LBT procedure is selected from LBT BW1 302, LBT BW2 304, LBT BW3, LBT BW4, etc. selected randomly or based on the selection criteria. In addition to performing the secondary LBT procedure, the UE 101a performs a tertiary LBT procedure, a quaternary LBT procedure, etc. according to the first LBT procedure 206, the second LBT procedure 208, third LBT procedure, fourth LBT procedure, etc. that are not associated with the primary LBT procedure. The first completed LBT procedure is one of the secondary, tertiary, quaternary LBT procedures, or the like, that completes first. In this example, the primary LBT procedure is the CAT-4 LBT and the secondary, tertiary, quaternary LBT procedure, or the like, are the CAT-2 LBT procedure. The SL message 202 is transmitted after performing the primary LBT procedure and after determining the first completed LBT procedure, where the SL message 202 is transmitted in a LBT BW associated with the first completed LBT procedure.

In another option, the UE 101a can perform CCA of the multiple LBT BWs including ending the primary LBT procedure early before completion at 210. This option can apply to the random selection option and selection criteria option presented above with an alternative operation to end the primary LBT procedure before completing the CAT-4 LBT (or abort the primary LBT procedure), and subsequently performing the first LBT procedure 206 and the second LBT procedure 208 according to the CAT-2 LBT. For example, the primary LBT procedure can be the CAT-4 LBT. The CAT-4 LBT includes a back-off counter, where when the UE 101a determines a LBT BW (e.g., LBT BW1 302 or LBT BW2 304) associated with the primary LBT procedure is busy, the primary LBT procedure includes sensing the LBT BW for a period of time. After sensing the LBT BW for the period of time, the UE 101a decrements the back-off counter, and can repeat sensing the LBT BW. When the back-off counter is equal to one or equal to zero, the UE 101a can end the primary LBT procedure early, or abort the primary LBT procedure, and subsequently determine the first completed LBT procedure according to the first LBT procedure 206 and the second LBT procedure 208 based on the CAT-2 LBT. The UE 101a can transmit the SL message 202 after aborting the primary LBT procedure and determining the first completed LBT procedure.

As the primary LBT procedure for the CAT-4 LBT includes a back-off the UE 101a may be able to transmit the SL message 202 sooner by aborting the primary LBT procedure and performing the first LBT procedure 206 and the second LBT procedure 208 according to the CAT-2 LBT.

In the alternative example with multiple LBT BWs, where the first completed LBT does not include CAT-2 LBT performed on the LBT BW associated with the primary LBT procedure, the primary LBT procedure can be aborted early. As such, the primary LBT procedure is ended early when the back-off counter is equal to one or equal to zero. After the primary LBT procedure is ended, the CAT-2 is not performed in the primary LBT BW. Rather, the CAT-2 LBT is performed independently and concurrently for the secondary, tertiary, quaternary LBT procedures associated with LBT BWs that are not associated with the primary LBT procedure.

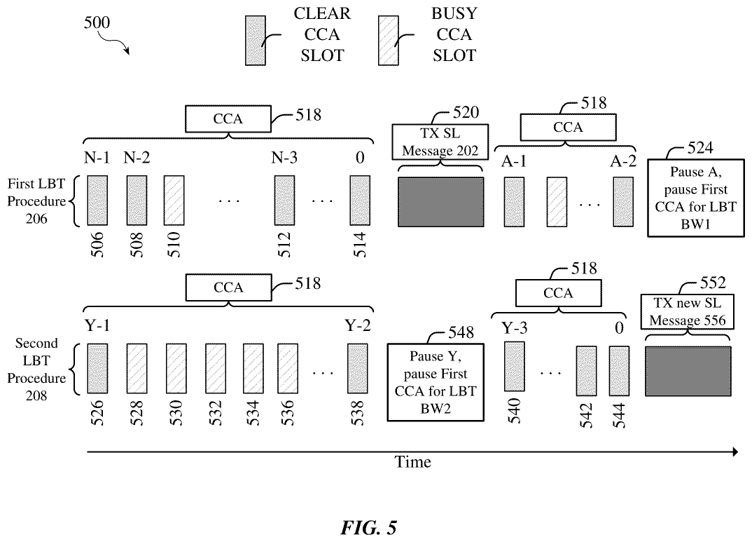

FIG. 5 shows a time diagram 500 of LBT procedures for LBT BW1 302 and LBT BW2 304 with an independent count down before transmitting the SL message 202 in one of LBT BW1 302 or LBT BW2 304 that overlaps with SL BWP 314. FIG. 5 shows LBT procedures for the LBT BWs that can be paused while the UE 101a transmits the SL message 202 in the first completed LBT procedure. This procedure can result in transmitting the SL message 202 sooner than other options as the UE 101a does not perform a CAT-2 LBT. As such, the independent count down option expends resources performing the CAT-4 LBT in the multiple LBT BWs, and transmits in the LBT BW of the first completed LBT procedure and does not expend resources performing the CAT-2 LBT. Rather than performing the CAT-4 LBT and subsequently performing multiple CAT-2 LBTs, the example of FIG. 5 can transmit sooner by performing multiple CAT-4 LBTs and not subsequently performing the CAT-2 LBT.

The UE 101a can draw a first random number (N) for the first LBT procedure 206 and a second random number (Y) for the second LBT procedure 208. As such, the first LBT procedure 206 and the second LBT procedure 208 can be performed concurrently and independently based on a CCA 518 (e.g., CAT-4 LBT). When either N or Y counts down to zero, the LBT procedure that has not counted down to zero is paused (e.g., at 548, Y has not counted down to zero). The counter for the LBT procedure that has not counted down to zero is paused, and the associated LBT procedure is paused (e.g., Y is paused at 548 and the second LBT procedure 208 is paused at 548). While the LBT procedure that has not counted down to zero is paused, the SL message 202 is transmitted at 520 after the first completed LBT procedure counts down to zero (e.g., the first LBT procedure 206 counts down to zero at CCA slot 514). After the SL message 202 is transmitted at 520, a new random number (A) is drawn for the associated LBT BW (e.g., LBT BW1 302), and the associated LBT procedure is reset (e.g., the first LBT procedure 206 is reset) and configured according to the CCA 518 (e.g., CAT-4 LBT) that is performed in the associated LBT BW according to A. A is decremented based on the UE 101a detecting a clear CCA slot. A is generated based on a CWS associated with the LBT BW of A (e.g., CWS associated with LBT BW1 302). After the SL message 202 is transmitted, the LBT procedure that has not counted down to zero (e.g., the second LBT procedure 208) is un-paused, or continues, and the countdown for the associated randomly generated number is un-paused, or continues (e.g., Y is un-paused). The above process of countdowns and pausing a counter and LBT procedure continues until another counter decrements to zero (e.g., Y counts down to zero at CCA slot 544). At which point the counter that has not counted down to zero and associated LBT procedure are paused (e.g., the reset first LBT procedure and A are paused) and a new SL message 556 is transmitted at 552 in the associated LBT BW where the counter decremented to zero (e.g., LBT BW2 304).

The time diagram 500 shows CCA slots across time, where solid CCA slots are clear CCA slots (e.g., CCA slots 506, 508, 512, 514, 528, 538, 540, 542, and 544) and hashed CCA slots are busy CCA slots (e.g., CCA slots 510, 528, 530, 532, 534, and 536). The LBT procedures (e.g., first LBT procedure 206 and second LBT procedure 208) are performed according to a CCA, for example, the CAT-4 LBT. While performing the CCA, bandwidths (e.g., LBT BW1 302 or LBT BW2 304) associated with a CCA slot are measured to determine if the CCA slot is clear or busy.

The first LBT procedure 206 and the second LBT procedure 208 begin at a same time where CCA slot 506 is measured according to LBT BW1 302 and the CCA 518 (e.g., CAT-4 LBT). Concurrently, CCA slot 526 is measured according to LBT BW2 304 and the CCA 518. When the first LBT procedure 206 detects that a measured CCA slot is clear, the UE 101a decrements N. For example, the UE 101a performs the CCA 518 at CCA slots 506, 508, 512, and 514 where N is decremented accordingly. The UE 101a performs the CCA 518 at CCA slot 510 and determines that LBT BW1 302 is busy, and thus N is not decremented at CCA slot 510. N decrements to zero at CCA slot 514. Concurrently, the UE 101a measures LBT BW2 304 and decrements Y to Y-1 after determining the CCA slot 526 is clear, does not decrement CCA slots 528, 530, 532, 534, and 536 as said CCA slots are busy, and subsequently determines CCA slot 538 is clear where Y is decremented.

When the UE 101a determines that N decrements to zero before Y decrements to zero, the UE 101a pauses Y and pauses the second LBT procedure 208 and transmits the SL message 202 at 520 in LBT BW1 302 and does not transmit the SL message 202 in LBT W2 304 (corresponding to SL message 202 transmission at 216 of FIG. 2). As such, the UE 101a determines that the first LBT procedure 206 is the first completed LBT procedure when N decrements to zero before Y decrements to zero. As such, the UE 101a transmits the SL message 202 after a first completed CAT-4 LBT and without subsequently performing a CAT-2 LBT as discussed in other options herein.

After transmitting the SL message 202 at 520, the UE 101a can continue performing CCA in LBT BW1 302 and LBT BW2 304 to subsequently transmit a new SL message 556. As such, the first LBT procedure 206 is reset after transmitting the SL message 202 and the UE 101a generates a new random number (A) for the first LBT procedure. A is generated according to the CWS associated with LBT BW1 302. Also, Y and the second LBT procedure are un-paused after transmitting the SL message 202 at 520. The UE 101a simultaneously performs the reset first LBT procedure according to the CCA (e.g., CAT-4 LBT), and continues performing the second LBT procedure where A is decremented when a CCA slot measured by the rest first LBT procedure is clear, and Y is decremented when the CCA slot measured by the second LBT procedure is clear. As such, the UE 101a can determine that Y decrements to zero, for example, at CCA slot 544, before A decrements to zero.

When Y decrements to zero, the UE 101a pauses A and pauses the reset first LBT procedure. Subsequently, the UE 101a transmits the new SL message 556 in LBT BW2 306 at 552 after Y decrements to zero.

In an alternative example (not depicted), A can decrement to zero before Y decrements to zero. For example, the UE 101a simultaneously performs the reset first LBT procedure according to the CCA (e.g., CAT-4 LBT), and continues performing the second LBT procedure after the SL message 202 is transmitted at 520. The UE 101a can determine that A decrements to zero before Y decrements to zero. When A decrements to zero, the UE 101a pauses Y and pauses the second LBT procedure 208. Subsequently, the UE 101a transmits the new SL message 556 in LBT BW1 302 after A decrements to zero.

The new SL message 556 can be transmitted based on decrements of the LBT procedure that precede the SL message 202. As such, the UE 101a can transmit subsequent SL messages after transmitting the SL message 202 based on already performed CCA thus minimizing the time sensing time between SL-U transmissions.

### SL-U Communications in LBT BW Guard Bands and Interlaced Waveforms

Enhancements to SL-U transmissions can include SL transmissions in a guard band of the multiple LBT BWs. As the SL BWP 314 can span across multiple LBT BWs, the UE 101a determines how to configure the SL message 202 based on whether the UE 101a can transmit in guard bands of the multiple LBT BWs. When intra-frequency guard band transmissions are enabled, the UE 101a can transmit the SL message 202 in guard bands thus increasing the transmission bandwidth for the SL message 202 relative to examples where guard band transmissions are disabled. Furthermore, the SL message 202 can be configured as an interlaced waveform or a continuous waveform. For example, when the SL message 202 is configured as the interlaced waveform, the SL message 202 is transmitted in a SL BWP 314 that is an integer of the multiple LBT BWs, or in other words, the SL message 202 is transmitted across the full BW of the multiple LBT BWs or one of the multiple LBT BWs and cannot be transmitted in a partial BW of the multiple LBT BWs. When the SL message 202 is configured as the continuous waveform, the SL message 202 can be transmitted in a partial BW of a LBT BW. As such, when the SL BWP is configured covering a partial LBT BW, and the interlaced waveform is configured, the SL BWP 314 may be reconfigured between integer multiples the multiple LBT BWs. For in-network operations, the guard band and waveform configuration can be received according to RRC signaling. For out-of-network operations, the guard band and waveform configuration can be pre-configured. Aspects of guard band enabled, guard band disabled, interlaced waveform, and continuous waveform options are discussed further herein.

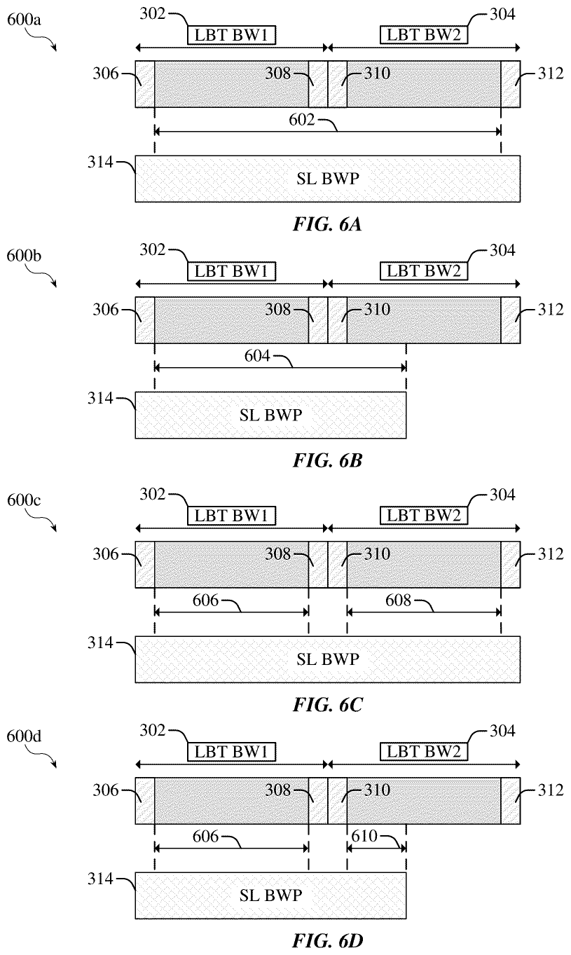

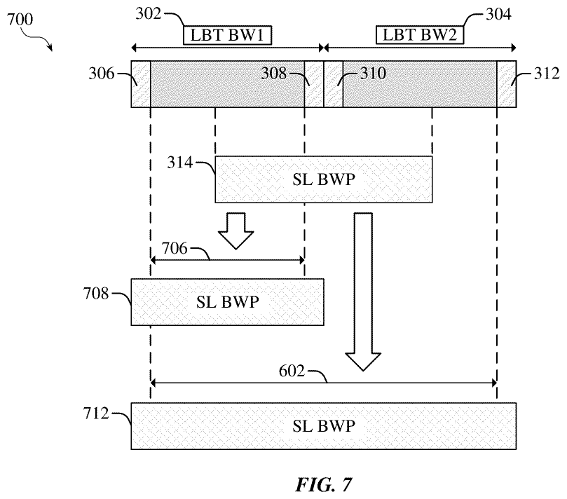

FIGS. 6A, 6B, 6C, 6D, and 7 illustrate resource diagrams 600a, 600b, 600c, 600d, and 700 showing multiple LBT BW and SL BWP configurations for guard band enabled, guard band disabled, interlaced waveforms, and continuous waveforms.

Now referring to FIGS. 2, 6A, 6B, 6C, 6D, 7 concurrently. Optionally, at 212 of FIG. 2, the UE 101a can receive from the BS 111a one or more of a guard band configuration or a waveform configuration. The guard band configuration can indicate to the UE 101a that intra-frequency SL-U communication within intra-frequency guard bands of multiple LBT BWs that overlap with the SL BWP 314 are enabled or disabled. The guard band configuration can be an RRC configuration indicated by intraCellGuardBandSL where intraCellGuardBandSL is enabled or disabled. In other aspect, the RRC configuration is indicated by another name, such as, intraBWPGuardBand-SL, and the indication name is not limited in this respect. In some aspects, the total number of resource blocks per LBT BW and per subcarrier spacing (SCS) can be configured based on intraCellGuardBandSL. The LBT BWs are configured according to resource blocks in the frequency domain. For example, for a 30 kHz SCS, the number of resource blocks within a resource set of a LBT BW can be between 50 and 56, and the guard bands are configured according to the resource blocks. In another example, for a 15 kHz SCS, the number of resource blocks within a resource set of a LBT BW can be between 100 and 110. In some aspects, the guard band configuration can indicate the starting index of the resource blocks and the size of the guard band resource blocks associated with the LBT BW. Thus, the UE 101a can derive the resource block index based on the starting index of the guard band and the size of the GB. Furthermore, the UE 101a can receive indication of intra-frequency guard bands of multiple LBT BWs.

The waveform configuration can indicate to the UE 101a if the SL message 202 is configured for the interlaced waveform or the continuous waveform. The RRC configuration can indicate the interlaced waveform by including useInterlaceWaveformSL in the RRC configuration. When the UE 101a does not detect useInterlaceWaveformSL, the UE 101a can configure a continuous waveform. In other aspects, the RRC configuration indicates use of the continuous waveform.

The configuration of interlaced waveform, continuous waveform, and guard band enabled or guard band disabled can be indicated in a system information block (SIB), a dedicated UE configuration, or part of a SL BWP configuration.

Resource diagram 600a of FIG. 6A shows SL BWP 314 extending between outer edges of GB1A 306 and GB2B 312 of LBT BW1 302 and LBT BW2 304 respectively where the SL BWP 314 overlaps intra-frequency GB1B 308 and GB2A 310. In this example, the UE 101a is configured to transmit in both LBT BW1 302 and LBT BW2 304 (e.g., as described in FIGS. 3A and 4). In this example, intraCellGuardBandSL is enabled, and the SL BWP 314 can transmit in intra-frequency GB1B 308 and GB2A 310 and the SL message 202 has a usable BW of 602 between neighboring band edges of GB1A 306 and GB2B 312. Because GB1A 306 and GB2B 312 are inter-frequency GB's, the SL message 202 cannot be transmitted in GB1A 306 and GB2B 312. As SL BWP 314 is configured over a full BW of LBT BW1 302 and a full BW of LBT BW2 304, the waveform configuration for SL BWP 314 does not affect guard band transmission.

Resource diagram 600b of FIG. 6B shows SL BWP 314 extending between the outer edges of GB1A 306 and to a resource location between GB2A 310 and GB2B 312. The SL BWP 314 is configured for the interlaced waveform and for intra-cell guard band transmission and the SL BWP 314 overlaps intra-frequency GB1B 308 and GB2A 310. In this example, the UE 101a is configured to transmit in both LBT BW1 302 and LBT BW2 304 (e.g., as described in FIGS. 3A and 4). As such, the SL message 202 cannot be transmitted in GB1A 306, but can transmit in intra-frequency GB1B 308 and GB2A 310. As such, the SL message 202 has a usable BW of 604 extending from an interior edge of GB1A 306 and extending to the resource between GB2A 310 and GB2B 312.

Resource diagram 600c of FIG. 6C shows SL BWP 314 extending between outer edges of GB1A 306 and GB2B 312 of LBT BW1 302 and LBT BW2 304 respectively where the SL BWP 314 overlaps intra-frequency GB1B 308 and GB2A 310. In this example, the UE 101a is configured to transmit in one of LBT BW1 302 or LBT BW2 304 according to the first completed LBT procedure (e.g., as described in FIGS. 3B and 5). In this example, regardless if intraCellGuardBandSL is enabled or disabled, the SL message 202 may not be transmitted in an intra-frequency guard band because the SL message 202 is transmitted in a portion of SL BWP 314 that overlaps with one of LBT BW1 302 or LBT BW2 304 based on the first completed LBT procedure. As such, if the first LBT procedure 206 is the first completed LBT procedure, then the UE 101a transmits the SL message 202 in a usable BW 606 defined between neighboring band edges of GB1A 306 and GB1B 308. Alternatively, if the second LBT procedure 208 is the first completed LBT procedure, then the UE 101a transmits the SL message 202 in a transmission BW 608 defined between neighboring band edges of GB2A 310 and GB2B 312.

Resource diagram 600d of FIG. 6D shows SL BWP 314 extending between the outer edges of GB1A 306 and to a resource location between GB2A 310 and GB2B 312, where intra-frequency guard band transmissions are disabled. When the UE 101a is configured to transmit in both LBT BW1 302 and LBT BW2 304 (e.g., as described in FIGS. 3A and 4), and the interlaced waveform is enabled, the SL message 202 can only be transmitted in an integer multiple of the multiple LBT BWs. As the SL BWP 314 spans a partial BW of LBT BW2 304, the UE 101 configures the SL message 202 for the usable BW 606. When the UE 101a is configured to transmit in both LBT BW1 302 and LBT BW2 304 (e.g., as described in FIGS. 3A and 4), and the continuous waveform is enabled, the SL message 202 can be transmitted in both LBT BW1 302 and LBT BW2 304, but cannot be transmitted in intra-frequency GBs. As such, the UE 101 configures the SL message 202 for the usable BW 606 of LBT BW1 302 and a usable BW 610 of LBT BW2 304 configured from an interior band edge of GB2A 310 extending to a resource between GB2A 310 and GB2B 312.

When the UE 101a is configured to transmit in one of LBT BW1 302 or LBT BW2 304 according to the first completed LBT procedure (e.g., as described in FIGS. 3B and 5), and the interlaced waveform is enabled, the SL message 202 can only be transmitted in an integer multiple of the multiple LBT BWs. As the SL BWP 314 spans a partial BW of LBT BW2 304, the UE 101a configures the SL message 202 for the usable BW 606 when the first completed LBT procedure is associated with LBT BW1 302. When the first LBT procedure is associated with LBT BW2 304, the UE 101a may not be able to transmit in usable BW 610 because usable BW 610 does not cover all of LBT BW2 304. As such, the UE 101a may need to reconfigure the SL BWP to cover all of LBT BW2 304, or wait for transmission availability according to usable BW 606.

When the UE 101a is configured to transmit in one of LBT BW1 302 or LBT BW2 304 according to the first completed LBT procedure (e.g., as described in FIGS. 3B and 5), and the continuous waveform is enabled, the SL message 202 can be transmitted in one of usable BW 606 or usable BW 610 according to the first completed LBT procedure. When the first completed LBT procedure is associated with LBT BW1 302, the SL message 202 is transmitted in usable BW 606. When the first completed LBT procedure is associated with LBT BW2 304, the SL message 202 is transmitted in usable BW 610.

Resource diagram 700 of FIG. 7 shows SL BWP 314 extending from an interior portion of LBT BW1 302 and an interior portion of LBT BW2 304, where the interlaced waveform is configured. As such, the SL BWP 314 does not extend over integer multiples of the multiple LBT BWs, but rather partial BWs of the multiple LBT BWs, and covers the intra-frequency guard bands of the multiple LBT BWs. As the interlaced waveform is configured, the UE 101a can send the SL message 202 in either all of LBT BW1 302, or all of LBT BW2 304, or a full BW extending between outer band edges of LBT BW1 302 and LBT BW2 304. As such, when the UE 101a is configured to transmit in both LBT BW1 302 and LBT BW2 304 (e.g., as described in FIGS. 3A and 4), the UE 101a cannot transmit the SL message 202 because the SL BWP 314 does not cover an integer multiple of the multiple BWPs. Alternatively, the UE 101a can re-configure the SL BWP 314 to a first alternative SL BWP 708 defined between outer band edges of LBT BW1 302. In this aspect, the SL message 202 can be transmitted in a usable BW 706 between neighboring band edges of GB1A 306 and GB1B 308. Alternatively, if intra-frequency guard bands are configured for SL-U, the SL message 202 can be transmitted in GB1B 308. In another alternative, the UE 101a can re-configure the SL BWP 314 to a second alternative SL BWP 712 defined between outer band edges of LBT BW1 302 and LBT BW2 304. In this aspect, the SL message 202 can be transmitted in a useable BW 602 defined between GB1A 306 and GB2A 312. In another alternative (not depicted), the UE 101a can reconfigure the SL BWP 314 to overlap between band edges of LBT BW2 304.

When the SL BWP 314 overlaps partial LBT BWs, and the UE 101a is configured to transmit in one of LBT BW1 302 or LBT BW2 304 (e.g., as described in FIGS. 3B and 5), the UE 101a either cannot transmit the SL message 202 because the SL BWP 314 does not cover an integer multiple of the multiple BWPs or the SL BWP 314 is reconfigured to overlap with one of LBT BW1 302 or LBT BW2 304.

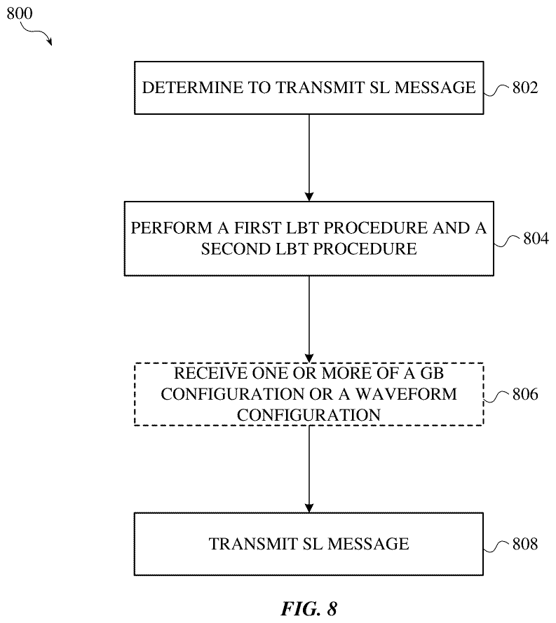

FIG. 8 illustrates a flow diagram of an example method 800 by which a UE performs bandwidth enhanced SL messaging in the unlicensed spectrum. The example method 800 may be performed, for example, by the UE 101 of FIG. 1.

At 802, the method includes determining to transmit a SL message. The SL message has a SL BWP that overlaps in frequency with multiple LBT BWs that are adjacent to one another. FIG. 2 at 204 corresponds to some aspects of act 802.

At 804, the method includes performing a first LBT procedure and a second LBT procedure. The first LBT procedure and the second LBT procedure are performed according to a category, for example, a CAT-4 LBT or a CAT-2 LBT. FIG. 2 at 210, and FIGS. 3A, 3B, 4, and 5 correspond to some aspects of act 804.

At 806, the method includes optionally receiving one of a guard band configuration or a waveform configuration according to RRC signaling. The guard band configuration can indicated to the UE that SL-U transmissions in intra-frequency guard bands of the multiple LBT BWs are enabled. The waveform configuration can indicated to the UE interlaced waveform or continuous waveform configuration of the SL message in the SL BWP. FIGS. 6A, 6B, 6C, 6D and 7 correspond to some aspects of act 806.

At 808, the method includes transmitting the SL message. The SL message can be transmitted in all of the multiple LBT BWs, or the SL message can be transmitted in a one of the multiple LBT BWs according to a first completed LBT procedure. FIG. 2 at 216 corresponds to some aspects of act 808.

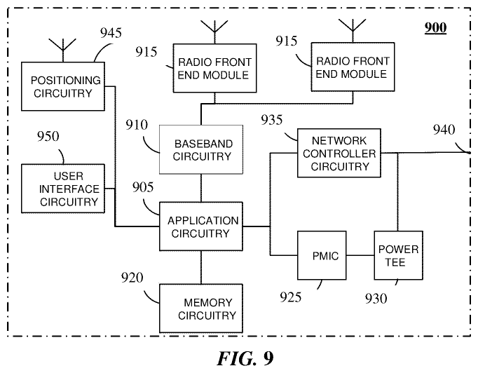

FIG. 9 illustrates an example of system 900 in accordance with various aspects. The system 900 (or “infrastructure equipment”) may be implemented as a base station, radio head, RAN node such as the BSs 111, or BS 111a, or BS 111b of FIG. 1 and/or any other element/component/device discussed herein. In other examples, the system 900 could be implemented in or by a UE such as UE 101, or UE 101a, or UE 101b of FIG. 1.

The system 900 includes application circuitry 905, baseband circuitry 910, one or more radio front end modules (RFEMs) 915, memory circuitry 920 (including a memory interface), power management integrated circuitry (PMIC) 925, power tee circuitry 930, network controller circuitry 935, network interface connector 940, satellite positioning circuitry 945, and user interface 950. In some aspects, the device of system 900 may include additional elements/components/devices such as, for example, memory/storage, display, camera, sensor, or input/output (I/O) interface. In other aspects, the components/devices described below may be included in more than one device. For example, said circuitries may be separately included in more than one device for CRAN, vBBU, or other like implementations.

The baseband circuitry 910 can be used to determine to transmit the SL message 202, perform first LBT procedure 206 and the second LBT procedure 208, receive guard band or waveform configurations, and transmit SL message 202.

Application circuitry 905 includes circuitry such as, but not limited to one or more processors (or processor cores), processing circuitry, cache memory, and one or more of low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 905 may be coupled with or may include memory/storage elements/components/devices and may be configured to execute instructions stored in the memory/storage to enable various applications or operating systems to run on the system 900. In some implementations, the memory/storage elements/components/devices may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 905 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more field programmable gate array (FPGAs), one or more PLDs, one or more application-specific integrated circuits (ASICs), one or more microprocessors or controllers, or any suitable combination thereof. In some aspects, the application circuitry 905 may comprise, or may be, a special-purpose processor/controller to operate according to the various aspects herein. As examples, the processor(s) of application circuitry 905 may include one or more Apple® processors, Intel® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium™, Inc.; a MIPS-based design from MIPS Technologies, Inc. such as MIPS Warrior P-class processors; and/or the like. In some aspects, the system 900 may not utilize application circuitry 905, and instead may include a special-purpose processor/controller to process IP data received from an EPC or 5GC, for example.

User interface 950 may include one or more user interfaces designed to enable user interaction with the system 900 or peripheral component or device interfaces designed to enable peripheral component or device interaction with the system 900. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component or device interfaces may include, but are not limited to, a nonvolatile memory port, a universal serial bus (USB) port, an audio jack, a power supply interface, etc.

The components or devices shown by FIG. 9 may communicate with one another using interface circuitry, that is communicatively coupled to one another, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an I2C interface, an SPI interface, point to point interfaces, and a power bus, among others.

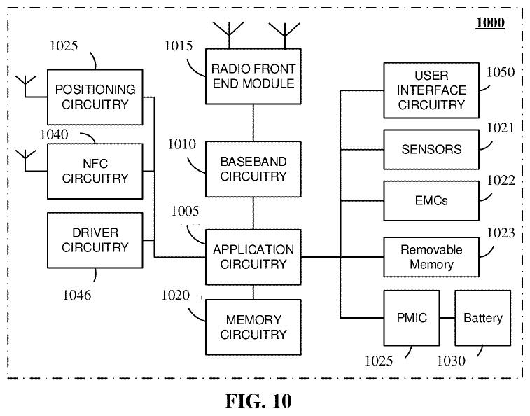

FIG. 10 illustrates an example of a platform 1000 (or “device 1000”) in accordance with various aspects. In aspects, the platform 1000 may be suitable for use as the UE 101, UE 101a, or UE 101b of FIG. 1, and/or any other element/component/device discussed herein such as the BSs 111, BS 111a, or BS 111b. The platform 1000 may include any combinations of the components or devices shown in the example. The components or devices of platform 1000 may be implemented as integrated circuits (ICs), portions thereof, discrete electronic devices, or other modules, logic, hardware, software, firmware, or a combination thereof adapted in the platform 1000, or as components or devices otherwise incorporated within a chassis of a larger system. The block diagram of FIG. 10 is intended to show a high level view of components or devices of the platform 1000. However, some of the components or devices shown may be omitted, additional components or devices may be present, and different arrangement of the components or devices shown may occur in other implementations.

Application circuitry 1005 includes circuitry such as, but not limited to one or more processors (or processor cores), memory circuitry 1020 (which includes a memory interface), cache memory, and one or more of LDOs, interrupt controllers, serial interfaces such as SPI, I2C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 1005 may be coupled with or may include memory/storage elements/component/device and may be configured to execute instructions stored in the memory/storage to enable various applications or operating systems to run on the system 1000. In some implementations, the memory/storage elements/components/devices may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The memory circuitry 1020 can be used to store the SL message 202, store guard band or waveform configurations, and store configurations of LBT procedures and associated bandwidths.

As examples, the processor(s) of application circuitry 1005 may include a general or special purpose processor, such as an A-series processor (e.g., the A13 Bionic), available from Apple® Inc., Cupertino, CA or any other such processor. The processors of the application circuitry 1005 may also be one or more of Advanced Micro Devices (AMD) Ryzen® processor(s) or Accelerated Processing Units (APUs); Core processor(s) from Intel® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 1005 may be a part of a system on a chip (SoC) in which the application circuitry 1005 and other components or devices are formed into a single integrated circuit, or a single package.

The baseband circuitry or processor 1010 may be implemented, for example, as a solder-down substrate including one or more integrated circuits, a single packaged integrated circuit soldered to a main circuit board or a multi-chip module containing two or more integrated circuits. Furthermore, the baseband circuitry or processor 1010 may cause transmission of various resources.

The platform 1000 may also include interface circuitry (not shown) that is used to connect external devices with the platform 1000. The interface circuitry may communicatively couple one interface to another. The external devices CONNECTED to the platform 1000 via the interface circuitry include sensor circuitry 1021 and electro-mechanical components (EMCs) 1022, as well as removable memory devices coupled to removable memory circuitry 1023.

A battery 1030 may power the platform 1000, although in some examples the platform 1000 may be mounted deployed in a fixed location, and may have a power supply coupled to an electrical grid. The battery 1030 may be a lithium ion battery, a metal-air battery, such as a zinc-air battery, an aluminum-air battery, a lithium-air battery, and the like. In some implementations, such as in V2X applications, the battery 1030 may be a typical lead-acid automotive battery.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or examples of the disclosure herein. Also, one or more of the acts depicted herein may be carried out in one or more separate acts and/or phases. In some examples, the methods illustrated above may be implemented in a computer readable medium or a non-transitory computer readable medium using instructions stored in a memory. Many other examples and variations are possible within the scope of the claimed disclosure.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components or devices, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units. The processor or baseband processor can be configured to execute instructions described herein.

A UE or a BS, for example the UE 101 or BSs 111 of FIG. 1 can comprise a memory interface and processing circuitry communicatively coupled to the memory interface configured to execute instructions described herein.

Examples (aspects) can include subject matter such as a method, means for performing acts or blocks of the method, at least one machine-readable medium including instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to aspects and examples described herein.

Example 1 is a baseband processor of a baseband processor of a user equipment (UE), comprising: one or more processors configured to: perform a first listen before talk (LBT) procedure and a second LBT procedure, wherein the first LBT procedure is performed according to a first LBT bandwidth (BW) (LBT BW1), and the second LBT procedure is performed according to a second LBT bandwidth (LBT BW2); and transmit a sidelink (SL) message, in an unlicensed spectrum, after completing the first LBT procedure and the second LBT procedure, wherein the SL message is transmitted in a SL BWP that overlaps with the LBT BW1 and the LBT BW2.

Example 2 includes Example 1, wherein the LBT BW1 and the LBT BW2 are adjacent.

Example 3 includes Example 1, wherein the one or more processors are further configured to: randomly select one of the LBT BW1 or the LBT BW2; perform a primary LBT procedure, where the primary LBT procedure is one of the first LBT procedure or the second LBT procedure associated with the randomly selected one of the LBT BW1 or the LBT BW2; after performing the primary LBT procedure, perform a secondary LBT procedure, where the secondary LBT procedure is one of the first LBT procedure or the second LBT procedure that is not the primary LBT procedure; and transmit the SL message after performing the primary LBT procedure and the secondary LBT procedure.

Example 4 includes Example 3, wherein the primary LBT procedure is a category 4 (CAT-4) LBT, and the secondary LBT procedure is a category 2 (CAT-2) LBT.

Example 5 includes Example 4, wherein the CAT-4 LBT includes a back-off counter, where when the UE determines a LBT BW associated with the primary LBT procedure is busy, the primary LBT procedure includes sensing the LBT BW for a period of time, decrements the back-off counter, and repeats sensing the LBT BW; and when the back-off counter is equal to one, the one or more processors are further configured to: abort the primary LBT procedure; perform the secondary LBT procedure according to the CAT-2 LBT; and transmit the SL message after performing the first LBT procedure and the second LBT procedure.

Example 6 includes Example 1, wherein the one or more processors are further configured to: select one of the LBT BW1 or the LBT BW2 based on a selection criteria; perform a primary LBT procedure, where the primary LBT procedure is one of the first LBT procedure or the second LBT procedure associated with the selected one of the LBT BW1 or the LBT BW2 based on the selection criteria; after performing the primary LBT procedure, perform a secondary LBT procedure, where the secondary LBT procedure is one of the first LBT procedure or the second LBT procedure that is not the primary LBT procedure; and transmit the SL message after performing the secondary LBT procedure.

Example 7 includes Example 6, wherein the primary LBT procedure is a category 4 (CAT-4) LBT, and the first LBT procedure and the second LBT procedure are a category 2 (CAT-2) LBT.

Example 8, includes Example 7, wherein the selection criteria is based on an index value of the LBT BW1 or an index value of the LBT BW2.

Example 9 includes Example 1, wherein the one or more processors are further configured to: randomly generate a first random number (N) for the first LBT procedure and randomly generate a second random number (Y) for the second LBT procedure; perform the first LBT procedure and the second LBT procedure according to a first clear channel assessment (CCA), wherein the first LBT procedure and the second LBT procedure are performed concurrently starting at a same time; decrement N when a CCA slot measured by the first LBT procedure is clear, and decrement Y when a CCA slot measured by the second LBT procedure is clear; determine that N decrements to zero before Y decrements to zero, and when N decrements to zero, pause N and pause the first LBT procedure, and continue performing the second LBT procedure; determine that Y decrements to zero and pause the second LBT procedure; and transmit the SL message after N and Y decrement to zero.

Example 10 includes Example 9, wherein the one or more processors are further configured to: update the first LBT procedure and the second LBT procedure to a second CCA after Y decrements to zero; simultaneously perform the first LBT procedure and the second LBT procedure according to the second CCA; and transmit the SL message after the first LBT procedure and the second LBT procedure complete the second CCA.

Example 11 includes Example 10, wherein the one or more processors are further configured to: receive a RRC configuration with one or more of a SL guard band configuration or a SL interlacing configuration; and one or more of interlace a waveform based on the SL interlacing configuration; or transmit the SL message in a guard band of the LBT BW1 or a guard band of the LBT BW2 based on the SL guard band configuration.

Example 13 includes Example 12, wherein the RRC configuration includes the SL interlacing configuration, and the SL message is interlaced based on the SL interlacing configuration, and the SL BWP overlaps with all of the LBT BW1 and all of the LBT BW2.

Example 14 includes Example 12, wherein the RRC configuration does not include the SL interlacing configuration, and the SL message is transmitted in a continuous waveform where the SL BWP overlaps with all of the LBT BW1 and overlaps with a subset of the LBT BW2.

Example 15 includes Example 14, wherein the RRC configuration further includes the SL guard band configuration; and the SL message is transmitted in an intra-frequency guard band of LBT BW1 and an intra-frequency guard band of LBT BW2 that is adjacent to the LBT BW1.

Example 16 is a baseband processor of a user equipment (UE), comprising: one or more processors configured to: perform a first listen before talk (LBT) procedure and a second LBT procedure, wherein the first LBT procedure is performed according to a first LBT bandwidth (BW) (LBT BW1), and the second LBT procedure is performed according to a second LBT bandwidth (LBT BW2); determine a first completed LBT procedure, wherein the first completed LBT procedure is one of the first LBT procedure or the second LBT procedure that completes first; and transmit a sidelink (SL) message, in an unlicensed spectrum, after determining the first completed LBT procedure, wherein the SL message is transmitted in a SL BWP that overlaps with a LBT BW of the first completed LBT procedure.

### Example 17 Includes Example 16, Wherein the LBT BW1 and the LBT BW2

are adjacent.

Example 18 includes Example 16, wherein the SL BWP overlaps with the LBT BW1 and the LBT BW2, and the one or more processors are further configured to: determine that the LBT BW of the first completed LBT procedure is less than the SL BWP, and reconfigure the SL BWP to the LBT BW of the first completed LBT procedure.

Example 19 includes Example 16, wherein the one or more processors are further configured to: randomly select one of the LBT BW1 or the LBT BW2 for a primary LBT procedure; perform the primary LBT procedure in the randomly selected one of the LBT BW1 or the LBT BW2; after performing the primary LBT procedure, determine the first completed LBT procedure; and transmit the SL message after performing the primary LBT procedure and after determining the first completed LBT procedure.

Example 20 includes Example 19, wherein the primary LBT procedure is a category 4 (CAT-4) LBT procedure, and the first LBT procedure and the second LBT procedure are a category 2 (CAT-2) LBT procedure.

Example 21 includes Example 20, wherein the CAT-4 LBT includes a back-off counter, where when the UE determines a LBT BW associated with the primary LBT procedure is busy, the CAT-4 LBT includes sensing the LBT BW associated with the primary LBT procedure for a period of time, and decrements the back-off counter, and repeats sensing the LBT BW associated with the primary LBT procedure; and when the back-off counter is equal to one, the one or more processors are further configured to: abort the primary LBT procedure; determine the first completed LBT procedure after aborting the third LBT procedure; and transmit the SL message after determining the first completed LBT procedure.

Example 22 includes Example 16, wherein the one or more processors are further configured to: select one of the LBT BW1 or the LBT BW2 based on a selection criteria for a primary LBT procedure; perform the primary LBT procedure in the selected one of the LBT BW1 or the LBT BW2 based on the selection criteria; after performing the primary LBT procedure, determine the first completed LBT procedure; and transmit the SL message after performing the primary LBT procedure and determining the first completed LBT procedure.

Example 23 includes Example 22, wherein the primary LBT procedure is a category 4 (CAT-4) LBT, and the first LBT procedure and the second LBT procedure are a category 2 (CAT-2) LBT.

Example 24 includes Example 23, wherein the selection criteria is based on an index value of the LBT BW1 or an index value of the LBT BW2.

Example 25 includes Example 16, wherein the one or more processors are further configured to: randomly generate a first random number (N) for the first LBT procedure and randomly generate a second random number (Y) for the second LBT procedure; perform the first LBT procedure and the second LBT procedure according to a clear channel assessment (CCA), wherein the CCA is a category 4 (CAT-4) LBT and wherein the first LBT procedure and the second LBT procedure are performed concurrently starting at a same time; decrement N when a CCA slot measured by the first LBT procedure is clear, and decrement Y when a CCA slot measured by the second LBT procedure is clear; determine that N decrements to zero before Y decrements to zero, and when N decrements to zero, pause Y and pause the second LBT procedure; determine that the first LBT procedure is the first completed LBT procedure; and transmit the SL message in the LBT BW1 after N decrements to zero.

Example 26 includes Example 25, wherein the one or more processors are further configured to: un-pause Y and the second LBT procedure after transmitting the SL message; reset the first LBT procedure and generate a new random number (A) for the first LBT procedure; and simultaneously perform the reset first LBT procedure according to the CCA and continue performing the second LBT procedure wherein A is decremented when a CCA slot measured by the reset first LBT procedure is clear, and decrement Y when the CCA slot measured by the second LBT procedure is clear.

Example 27 incudes Example 26, wherein the one or more processors are further configured to: determine that Y decrements to zero before A decrements to zero; and when Y decrements to zero, pause A and pause the reset first LBT procedure; and transmit a new SL message in the LBT BW2 after Y decrements to zero.

Example 28 includes Example 26, wherein the one or more processors are further configured to: determine that A decrements to zero before Y decrements to zero; and when A decrements to zero, pause Y and pause the second LBT procedure; and transmit a new SL message in the LBT BW1 after A decrements to zero.

Example 29 includes Example 16, wherein the one or more processors are further configured to: receive a RRC configuration with a guard band configuration for SL (intraCellGuardBandSL configuration), wherein the intraCellGuardBandSL configuration indicates a guard band start index, and a size of the guard band; determine a guard band at band edges of the BW of the first completed LBT procedure based on the intraCellGuardBandSL configuration; and transmit the SL message between the guard band at band edges of the BW of the first completed LBT procedure.

Example 30 is a user equipment (UE), comprising: a radio frequency (RF) transceiver and one or more processors configured to, when executing instructions stored in a memory, cause the UE to: perform a first listen before talk (LBT) procedure, a second LBT procedure, and a third LBT procedure, wherein the first LBT procedure is performed according to a first LBT bandwidth (BW) (LBT BW1), the second LBT procedure is performed according to a second LBT bandwidth (LBT BW2), and the third LBT procedure is performed according to a third LBT bandwidth (LBT BW3), wherein a plurality of LBTs are the LBT BW1, the LBT BW2, and the LBT BW3; select the LBT BW3 from the plurality of LBTs; perform the third LBT procedure based on selecting the LBT BW3; after performing the third LBT procedure, perform the first LBT procedure and the second LBT procedure; determine a first completed LBT procedure, wherein the first completed LBT procedure is one of the first LBT procedure or the second LBT procedure that completes first; and transmit a sidelink (SL) message, in an unlicensed spectrum, after determining the first completed LBT procedure, wherein the SL message is transmitted in a SL BWP that overlaps with a LBT BW of the first completed LBT procedure.

Example 31 includes Example 30, wherein the LBT BW1 and the LBT BW2 are adjacent.

Example 32 includes Example 30, wherein the SL BWP overlaps with the LBT BW1 and the LBT BW2, and the one or more processors are further configured to cause the UE to: determine that the LBT BW of the first completed LBT procedure is less than the SL BWP, and reconfigure the SL BWP to the LBT BW of the first completed LBT procedure.

Example 33 includes Example 30, wherein the one or more processors are further configured to: randomly select the LBT BW3 from the plurality of LBTs; and perform the third LBT procedure in the LBT BW3 based on randomly selecting the LBT BW3.

Example 34 includes Example 33, wherein the third LBT procedure is a category 4 (CAT-4) LBT procedure, and the first LBT procedure and the second LBT procedure are a category 2 (CAT-2) LBT procedure.

Example 35 includes Example 34, wherein the CAT-4 LBT includes a back-off counter, where when the UE determines that LBT BW3 is busy, the CAT-4 LBT includes sensing the LBT BW3 for a period of time, and decrements the back-off counter, and repeats sensing the LBT BW3; and when the back-off counter is equal to one, the one or more processors are further configured to: abort the third LBT procedure; determine the first completed LBT procedure after aborting the third LBT procedure; and transmit the SL message after determining the first completed LBT procedure.

Example 36 includes Example 30, wherein the one or more processors are further configured to cause the UE to: select the LBT BW3 from the plurality of LBTs based on a selection criteria; and perform the third LBT procedure in the LBT BW3 based on selecting the LBT BW3.

Example 37 includes Example 36, wherein the third LBT procedure is a category 4 (CAT-4) LBT, and the first LBT procedure and the second LBT procedure are a category 2 (CAT-2) LBT.

Example 38 includes Example 37, wherein the selection criteria is based on an index value of the LBT BW1 or an index value of the LBT BW2.

Example 39 includes Example 30, wherein the one or more processors are further configured to: receive a RRC configuration with a guard band configuration for SL (intraCellGuardBandSL configuration), wherein the intraCellGuardBandSL configuration indicates a guard band start index, and a size of the guard band; determine a guard band at band edges of the BW of the first completed LBT procedure based on the intraCellGuardBandSL configuration; and transmit the SL message between the guard band at band edges of the BW of the first completed LBT procedure.

A method as substantially described herein with reference to each or any combination substantially described herein, comprised in examples 1-39, and in the Detailed Description.

A non-transitory computer readable medium as substantially described herein with reference to each or any combination substantially described herein, comprised in examples 1-39, and in the Detailed Description.

A wireless device configured to perform any action or combination of actions as substantially described herein, comprised in examples 1-39, and in the Detailed Description.

An integrated circuit configured to perform any action or combination of actions as substantially described herein, comprised in examples 1-39, and in the Detailed Description.

An apparatus configured to perform any action or combination of actions as substantially described herein, comprised in examples 1-39, and in the Detailed Description.

A baseband processor configured to perform any action or combination of actions as substantially described herein, comprised in examples 1-39, and in the Detailed Description.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.).

Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communication media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal or apparatus.

In this regard, while the disclosed subject matter has been described in connection with various aspects and corresponding Figures, where applicable, it is to be understood that other similar aspects can be used or modifications and additions can be made to the described aspects for performing the same, similar, alternative, or substitute function of the disclosed subject matter without deviating therefrom. Therefore, the disclosed subject matter should not be limited to any single aspect described herein, but rather should be construed in breadth and scope in accordance with the appended claims below.

In particular regard to the various functions performed by the above described components or devices (assemblies, devices, circuits, systems, etc.), the terms (including a reference to a “means”) used to describe such components or devices are intended to correspond, unless otherwise indicated, to any component, device, or structure which performs the specified function of the described component or device (e.g., that is functionally equivalent), even though not structurally equivalent to the disclosed structure which performs the function in the herein illustrated exemplary implementations of the disclosure. In addition, while a particular feature can have been disclosed with respect to only one of several implementations, such feature can be combined with one or more other features of the other implementations as can be desired and advantageous for any given or particular application.

The present disclosure is described with reference to the attached drawing figures, wherein like reference numerals are used to refer to like elements, devices, or components throughout, and wherein the illustrated structures and devices are not necessarily drawn to scale. As utilized herein, terms “device,” “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”Further, these components can execute from various computer readable or non-transitory computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

As used herein, the term “circuitry” can refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some aspects, the circuitry can be implemented in, or functions associated with the circuitry can be implemented by, one or more software or firmware modules. In some aspects, circuitry can include logic, at least partially operable in hardware.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A baseband processor of a user equipment (UE), comprising:
one or more processors configured to:
perform a first listen before talk (LBT) procedure and a second LBT procedure, wherein the first LBT procedure is performed according to a first LBT bandwidth (BW) (LBT BW1), and the second LBT procedure is performed according to a second LBT bandwidth (LBT BW2); and
cause transmission of, by a radio frequency (RF) circuitry), a sidelink (SL) message, in an unlicensed spectrum, after completing the first LBT procedure and the second LBT procedure, wherein the SL message is transmitted in a SL BWP that overlaps with the LBT BW1 and the LBT BW2.

2. The baseband processor of claim 1, wherein the one or more processors are further configured to:
randomly select one of the LBT BW1 or the LBT BW2;
perform a primary LBT procedure, where the primary LBT procedure is one of the first LBT procedure or the second LBT procedure associated with the randomly selected one of the LBT BW1 or the LBT BW2;
after performing the primary LBT procedure, perform a secondary LBT procedure, where the secondary LBT procedure is one of the first LBT procedure or the second LBT procedure that is not the primary LBT procedure; and
cause transmission of the SL message after performing the primary LBT procedure and the secondary LBT procedure.

3. The baseband processor of claim 2, wherein the primary LBT procedure is a category 4 (CAT-4) LBT, and the secondary LBT procedure is a category 2 (CAT-2) LBT.

4. The baseband processor of claim 3, wherein the CAT-4 LBT includes a back-off counter, where when the UE determines a LBT BW associated with the primary LBT procedure is busy, the primary LBT procedure includes sensing the LBT BW for a period of time, decrements the back-off counter, and repeats sensing the LBT BW; and
when the back-off counter is equal to one, the one or more processors are further configured to:
abort the primary LBT procedure;
perform the secondary LBT procedure according to the CAT-2 LBT; and
cause transmission of the SL message after performing the first LBT procedure and the second LBT procedure.

5. The baseband processor of claim 1, wherein the one or more processors are further configured to:
select one of the LBT BW1 or the LBT BW2 based on a selection criteria;
perform a primary LBT procedure, where the primary LBT procedure is one of the first LBT procedure or the second LBT procedure associated with the selected one of the LBT BW1 or the LBT BW2 based on the selection criteria, and wherein the primary LBT procedure is a category 4 (CAT-4) LBT;
after performing the primary LBT procedure, perform a secondary LBT procedure, where the secondary LBT procedure is one of the first LBT procedure or the second LBT procedure that is not the primary LBT procedure, and wherein the first LBT procedure and the second LBT procedure are performed according to a category 4 (CAT-4) LBT; and
cause transmission of the SL message after performing the secondary LBT procedure.

6. (canceled)

7. The baseband processor of claim 1, wherein the one or more processors are further configured to:
randomly generate a first random number (N) for the first LBT procedure and randomly generate a second random number (Y) for the second LBT procedure;
perform the first LBT procedure and the second LBT procedure according to a first clear channel assessment (CCA), wherein the first LBT procedure and the second LBT procedure are performed concurrently starting at a same time;
decrement N when a CCA slot measured by the first LBT procedure is clear, and decrement Y when a CCA slot measured by the second LBT procedure is clear;
determine that N decrements to zero before Y decrements to zero, and when N decrements to zero, pause N and pause the first LBT procedure, and continue performing the second LBT procedure;
determine that Y decrements to zero and pause the second LBT procedure; and
cause transmission of the SL message after N and Y decrement to zero.

8. The baseband processor of claim 7, wherein the one or more processors are further configured to:
update the first LBT procedure and the second LBT procedure to a second CCA after Y decrements to zero; wherein the first CCA is a category 4 (CAT-4) LBT and the second CCA is a CAT-2 LBT;
simultaneously perform the first LBT procedure and the second LBT procedure according to the second CCA; and
cause transmission of the SL message after the first LBT procedure and the second LBT procedure complete the second CCA.

9-11. (canceled)

12. A baseband processor of a user equipment (UE), comprising:
one or more processors configured to:
perform a first listen before talk (LBT) procedure and a second LBT procedure, wherein the first LBT procedure is performed according to a first LBT bandwidth (BW) (LBT BW1), and the second LBT procedure is performed according to a second LBT bandwidth (LBT BW2);
determine a first completed LBT procedure, wherein the first completed LBT procedure is one of the first LBT procedure or the second LBT procedure that completes first; and
cause transmission of, by a radio frequency (RF) circuitry), a sidelink (SL) message, in an unlicensed spectrum, after determining the first completed LBT procedure, wherein the SL message is transmitted in a SL BWP that overlaps with a LBT BW of the first completed LBT procedure.

13. The baseband processor of claim 12, wherein the SL BWP overlaps with the LBT BW1 and the LBT BW2, and the one or more processors are further configured to:
determine that the LBT BW of the first completed LBT procedure is less than the SL BWP, and reconfigure the SL BWP to the LBT BW of the first completed LBT procedure.

14. The baseband processor of claim 12, wherein the one or more processors are further configured to:
randomly select one of the LBT BW1 or the LBT BW2 for a primary LBT procedure;
perform the primary LBT procedure in the randomly selected one of the LBT BW1 or the LBT BW2, wherein the primary LBT procedure is a category 4 (CAT-4) LBT;
after performing the primary LBT procedure, determine the first completed LBT procedure, wherein the first LBT procedure and the second LBT procedure are a category 2 (CAT-2) LBT; and
cause transmission of the SL message after performing the primary LBT procedure and after determining the first completed LBT procedure.

15. The baseband processor of claim 12, wherein the one or more processors are further configured to:
select one of the LBT BW1 or the LBT BW2 based on a selection criteria for a primary LBT procedure;
perform the primary LBT procedure in the selected one of the LBT BW1 or the LBT BW2 based on the selection criteria, wherein the primary LBT procedure is a category 4 (CAT-4) LBT;
after performing the primary LBT procedure, determine the first completed LBT procedure, wherein the first LBT procedure and the second LBT procedure are a category 2 (CAT-2) LBT; and
cause transmission of the SL message after performing the primary LBT procedure and determining the first completed LBT procedure.

16. The baseband processor of claim 12, wherein the one or more processors are further configured to:
randomly generate a first random number (N) for the first LBT procedure and randomly generate a second random number (Y) for the second LBT procedure;
perform the first LBT procedure and the second LBT procedure according to a clear channel assessment (CCA), wherein the CCA is a category 4 (CAT-4) LBT and wherein the first LBT procedure and the second LBT procedure are performed concurrently starting at a same time;
decrement N when a CCA slot measured by the first LBT procedure is clear, and decrement Y when a CCA slot measured by the second LBT procedure is clear;
determine that N decrements to zero before Y decrements to zero, and when N decrements to zero, pause Y and pause the second LBT procedure;
determine that the first LBT procedure is the first completed LBT procedure;
cause transmission of the SL message in the LBT BW1 after N decrements to zero;
un-pause Y and the second LBT procedure after transmitting the SL message;
reset the first LBT procedure and generate a new random number (A) for the first LBT procedure; and
simultaneously perform the reset first LBT procedure according to the CCA and continue performing the second LBT procedure wherein A is decremented when a CCA slot measured by the reset first LBT procedure is clear, and decrement Y when the CCA slot measured by the second LBT procedure is clear.

17. A user equipment (UE), comprising:
a radio frequency (RF) transceiver and one or more processors configured to,
when executing instructions stored in a memory, cause the UE to:
perform a first listen before talk (LBT) procedure, a second LBT procedure, and a third LBT procedure, wherein the first LBT procedure is performed according to a first LBT bandwidth (BW) (LBT BW1), the second LBT procedure is performed according to a second LBT bandwidth (LBT BW2), and the third LBT procedure is performed according to a third LBT bandwidth (LBT BW3), wherein a plurality of LBTs are the LBT BW1, the LBT BW2, and the LBT BW3;
select the LBT BW3 from the plurality of LBTs;
perform the third LBT procedure based on selecting the LBT BW3;
after performing the third LBT procedure, perform the first LBT procedure and the second LBT procedure;
determine a first completed LBT procedure, wherein the first completed LBT procedure is one of the first LBT procedure or the second LBT procedure that completes first; and
transmit, by the RF transceiver, a sidelink (SL) message, in an unlicensed spectrum, after determining the first completed LBT procedure, wherein the SL message is transmitted in a SL BWP that overlaps with a LBT BW of the first completed LBT procedure.

18. The UE of claim 17, wherein the one or more processors are further configured to cause the UE to:
randomly select the LBT BW3 from the plurality of LBTs; and
perform the third LBT procedure in the LBT BW3 based on randomly selecting the LBT BW3, wherein the third LBT procedure is a category 4 (CAT-4) LBT and the first LBT procedure and the second LBT procedure are a category 2 (CAT-2) LBT.

19. The UE of claim 18, wherein the CAT-4 LBT includes a back-off counter, where when the UE determines that LBT BW3 is busy, the CAT-4 LBT includes sensing the LBT BW3 for a period of time, and decrements the back-off counter, and repeats sensing the LBT BW3; and
when the back-off counter is equal to one, the one or more processors are further configured to:
abort the third LBT procedure;
determine the first completed LBT procedure after aborting the third LBT procedure; and
transmit the SL message after determining the first completed LBT procedure.

20. The UE of claim 17, wherein the one or more processors are further configured to cause the UE to:
select the LBT BW3 from the plurality of LBTs based on a selection criteria; and
perform the third LBT procedure in the LBT BW3 based on selecting the LBT BW3, wherein the third LBT procedure is a category 4 (CAT-4) LBT and the first LBT procedure and the second LBT procedure are a category 2 (CAT-2) LBT.

21. The baseband processor of claim 1, wherein the one or more processors are further configured to:
receive a RRC configuration with a SL interlacing configuration;
generate the SL message as an interlaced waveform based on the SL interlacing configuration; and
transmit the SL message in the SL BWP.

22. The baseband processor of claim 21, wherein the RRC configuration includes a subcarrier spacing (SCS) configuration, and a total number of resource blocks (RBs) for the interlaced waveform is determined based on the subcarrier spacing (SCS).

23. The baseband processor of claim 1, wherein the one or more processors are further configured to:
receive a RRC configuration with a SL guard band configuration; and
transmit the SL message in a guard band of the LBT BW1 or a guard band of the LBT BW2 based on the SL guard band configuration.

24. The baseband processor of claim 23, wherein the guard band of LBT BW1 is an intra-frequency guard band and the guard band of LBT BW2 is an intra-frequency guard band that is adjacent to the guard band of LBT BW1; and
the SL message is transmitted in the guard band of the LBT BW1 and the guard band of the LBT BW2.
